(19) United States
(12) Patent Application Publication
(10) Pub. No.: US 2026/0355793 A1
(43) Pub. Date: Nov. 12, 2026

(54) APPARATUS FOR CLEANING INTERIOR OF PIPE

(71) Applicant: Samsung Electronics Co., Ltd., Suwon-si (KR)

(72) Inventors: Ji Hyeong LEE, Suwon-si (KR); Inwook KOO, Suwon-si (KR); Sang Woo UM, Suwon-si (KR); Chan Ho LEE, Suwon-si (KR); Byeong Chan JEONG, Suwon-si (KR); Eui Jin KIM, Suwon-si (KR); Tai Jong SUNG, Suwon-si (KR)

(21) Appl. No.: 19/369,256

(22) Filed: Oct. 26, 2025

(30) Foreign Application Priority Data
May 9, 2025 (KR) 10-2025-0060276

(51) Int. Cl. B08B 9/049; B08B 9/032; B08B 9/035

(52) U.S. Cl. CPC B08B 9/049; B08B 9/0325; B08B 9/035

(57) ABSTRACT

An apparatus for cleaning the interior of a pipe according to some embodiments of the present disclosure is provided. The apparatus for cleaning the interior of a pipe includes a cleaning unit configured to spray a cleaning liquid into the interior of the pipe at a predetermined pressure and thereby clean the interior of the pipe while traveling in a first direction inside the pipe; and a collection and regeneration unit configured to supply the cleaning liquid to the cleaning unit, collect cleaning waste formed by a mixture of the cleaning liquid sprayed into the interior of the pipe and foreign matter from the inside of the pipe, and filter the collected cleaning waste and thereby regenerate the cleaning liquid from the cleaning waste.

### CROSS-REFERENCE TO RELATED APPLICATION

This application claims priority under 35 U.S.C. § 119 from Korean Patent Application No. 10-2025-0060276 filed on May 9, 2025, in the Korean Intellectual Property Office, and all the benefits accruing therefrom under 35 U.S.C. § 119, the contents of which in its entirety are herein incorporated by reference.

### BACKGROUND

### 1. Field

The present disclosure relates to an apparatus for cleaning the interior of a pipe.

### 2. Description of the Related Art

Various types of foreign substances such as sludge, powder, and solids accumulate inside pipes, including industrial pipes and household pipes. When foreign substances accumulate inside pipes, the flow path of the pipes may become narrowed or blocked due to the foreign substances, which can impose a load on facilities connected to the pipes and lead to malfunctions. In particular, when foreign substances accumulate inside industrial pipes, it may lead to serious problems such as disruptions in production.

Inside pipes connected to facilities used in semiconductor manufacturing processes, foreign substances containing toxic materials along with moisture accumulate due to by-products generated during the semiconductor manufacturing processes. In other words, toxic, sludge-type foreign substances may accumulate inside pipes connected to a facility used in semiconductor manufacturing processes. For example, toxic, sludge-type foreign substances accumulate inside pipes that connect a scrubber for processing by-products generated during the semiconductor manufacturing process and an exhaust duct through which gases treated by the scrubber are discharged to the outside. Cleaning the inside of such pipes is classified as a high-risk task due to chemical hazards and safety issues for the workers.

To clean the inside of pipes connected to a facility used in semiconductor manufacturing processes, workers must wear appropriate protective clothing to prevent exposer of the skin to toxic materials during pipe cleaning. In addition, cleaning the inside of such pipes involves first disconnecting the pipes from the facility, then separating the disconnected pipes from each other, and sealing the separated pipes. The sealed pipes are then transported to a cleaning chamber, where the inside of each pipe is cleaned. After cleaning the inside of each pipe, the cleaned pipes are returned to the facility, assembled, and reconnected. Thus, cleaning the inside of pipes connected to the facility used in semiconductor manufacturing processes is a task with high difficulty and requires a long working time.

Meanwhile, the inside of pipes can be cleaned using a pipe-interior cleaning apparatus. However, conventional pipe-interior cleaning apparatuses are mainly intended for cleaning the inside of large pipes and are not suitable for cleaning the inside of small pipes, such as those connected to a facility used in semiconductor manufacturing processes. Moreover, although conventional pipe-interior cleaning apparatuses include brushes and can clean powder-form foreign substances, they have difficulty cleaning the inside of pipes where sludge-type foreign substances accumulate, such as pipes connected to a facility used in semiconductor manufacturing processes.

### SUMMARY

One objective of the present disclosure is to provide an apparatus for cleaning the interior of a pipe, capable of injecting a cleaning liquid into the inside of a pipe at a predetermined pressure to clean the inside of the pipe, collecting cleaning waste, formed by the mixture of the cleaning liquid injected into the pipe and foreign substances inside the pipe, so that the cleaning waste is not discharged outside the pipe, and filtering the collected cleaning waste to regenerate the cleaning liquid from the cleaning waste.

The objectives of the present disclosure are not limited to those mentioned above, and other objectives not explicitly stated will be clearly understood by those skilled in the art based on the following description.

An apparatus for cleaning an interior of a pipe according to some embodiments of the present disclosure is provided. The apparatus for cleaning the interior of the pipe comprises a cleaning unit configured to spray a cleaning liquid into the interior of the pipe at a predetermined pressure and thereby clean the interior of the pipe while traveling in a first direction inside the pipe; and a collection and regeneration unit configured to supply the cleaning liquid to the cleaning unit, collect cleaning waste formed by a mixture of the cleaning liquid sprayed into the interior of the pipe and foreign matter from the inside of the pipe, and filter the collected cleaning waste and thereby regenerate the cleaning liquid from the cleaning waste.

An apparatus for cleaning an interior of a pipe according to some embodiments of the present disclosure is provided. The apparatus for cleaning the interior of the pipe comprises a cleaning unit configured to spray a cleaning liquid into the interior of the pipe at a predetermined pressure and thereby clean the interior of the pipe, or spray air into the interior of the pipe that has been cleaned and thereby dry the interior of the pipe that has been cleaned, while traveling inside the pipe; and a collection and regeneration unit configured to supply the cleaning liquid or the air to the cleaning unit, collect cleaning waste formed by a mixture of the cleaning liquid sprayed into the interior of the pipe and foreign matter from the inside of the pipe, and filter the collected cleaning waste and thereby regenerate the cleaning liquid from the cleaning waste, wherein the collection and regeneration unit includes: a waste collector configured to collect the cleaning waste; a cleaning liquid tank configured to store the cleaning liquid to be supplied to the cleaning unit and in which the cleaning waste collected in the waste collector is filtered to be regenerated and stored as the cleaning liquid; a cleaning liquid pump configured to supply the cleaning liquid from the cleaning liquid tank to the cleaning unit; and an air supplier configured to supply the air to the cleaning unit.

An apparatus for cleaning an interior of a pipe according to some embodiments of the present disclosure is provided. The apparatus for cleaning the interior of the pipe comprises a cleaning unit configured to travel inside the pipe and spray a cleaning liquid into the interior of the pipe at a predetermined pressure to clean the interior of the pipe; a traveling unit detachably connected to the cleaning unit and configured to move the cleaning unit inside the pipe; a flexible connection unit detachably connected to the cleaning unit and the traveling unit and configured to flexibly connect the cleaning unit and the traveling unit; and a collection and regeneration unit configured to supply the cleaning liquid to the cleaning unit, collect cleaning waste formed by a mixture of the cleaning liquid sprayed into the interior of the pipe and foreign matter from the inside of the pipe, and filter the collected cleaning waste to regenerate the cleaning liquid from the cleaning waste.

Specific details of other embodiments are included in the detailed description and drawings.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a diagram illustrating an apparatus for cleaning the interior of a pipe according to some example embodiments of the present disclosure.

FIG. 2 is a perspective view illustrating the cleaning unit, the flexible connection units, and the traveling unit of the apparatus of FIG. 1.

FIG. 3 is a cross-sectional view taken along line I-I′ in FIG. 2.

FIG. 4 is an enlarged cross-sectional view of the cleaning unit in FIG. 3.

FIG. 5 is a schematic view illustrating an arrangement in which the collection guide member of the waste collection guide unit of the apparatus of FIG. 1 is arranged inside a curved pipe.

FIG. 6 illustrates enlarged views of one of the nozzle centering units of the cleaning unit of FIG. 4.

FIG. 7 is a cross-sectional view of the tube branching connector of the apparatus of FIG. 1.

FIG. 8 is a view illustrating a state in which cleaning liquid is sprayed by the cleaning unit of the apparatus of FIG. 1.

FIG. 9 is a view illustrating a state in which air is sprayed by the cleaning unit of the apparatus of FIG. 1.

FIG. 10 is a flowchart illustrating a method of cleaning the interior of a pipe using the apparatus of FIG. 1, according to example embodiments.

FIG. 11 is a view illustrating the cleaning unit of the apparatus of FIG. 1 being inserted into the pipe to be cleaned in the method of FIG. 10.

FIG. 12 is a view illustrating the cleaning unit cleaning the interior of the pipe by spraying a cleaning liquid into the pipe while traveling in the first direction inside the pipe in the method of FIG. 10.

FIG. 13 is a view illustrating the collection and regeneration unit supplying the cleaning liquid to the cleaning unit, collecting cleaning waste, and filtering the cleaning waste to regenerate the cleaning liquid from the cleaning waste in the method of FIG. 10.

FIG. 14 is a view illustrating the cleaning unit spraying the cleaning liquid into the cleaned pipe to clean the interior of the waste collection tube of the collection and regeneration unit after the interior of the pipe is cleaned with the cleaning liquid in the method of FIG. 10.

FIG. 15 is a view illustrating the collection and regeneration unit supplying the cleaning liquid to the cleaning unit to clean the interior of the waste collection tube of the collection and regeneration unit in the method of FIG. 10.

FIG. 16 is a view illustrating the cleaning unit spraying air into the cleaned pipe to dry the interior of the cleaned pipe while traveling in the second direction in the method of FIG. 10.

FIG. 17 is a view illustrating the collection and regeneration unit supplying air to the cleaning unit to dry the interior of the cleaned pipe in the method of FIG. 10.

### DETAILED DESCRIPTION

Although terms such as first, second, upper, and lower are used herein to describe various elements or components, it is obvious that these elements or components are not limited by the terms. Rather, the terms are merely used herein to distinguish one element or component from another element or component. Therefore, it is obvious that a first element or component as mentioned below may also be a second element or component within the technical spirit of the present disclosure. Further, it is obvious that a lower element or component as mentioned below may also be an upper element or component within the technical spirit of the present disclosure.

Hereinafter, embodiments of the present disclosure are described in detail with reference to the attached drawings. The same reference numerals are used for the same components in the drawings, and duplicate descriptions thereof are not repeated.

As used herein, items described as being “fluidly connected” are configured such that a liquid or gas can flow, or be passed, from one item to the other.

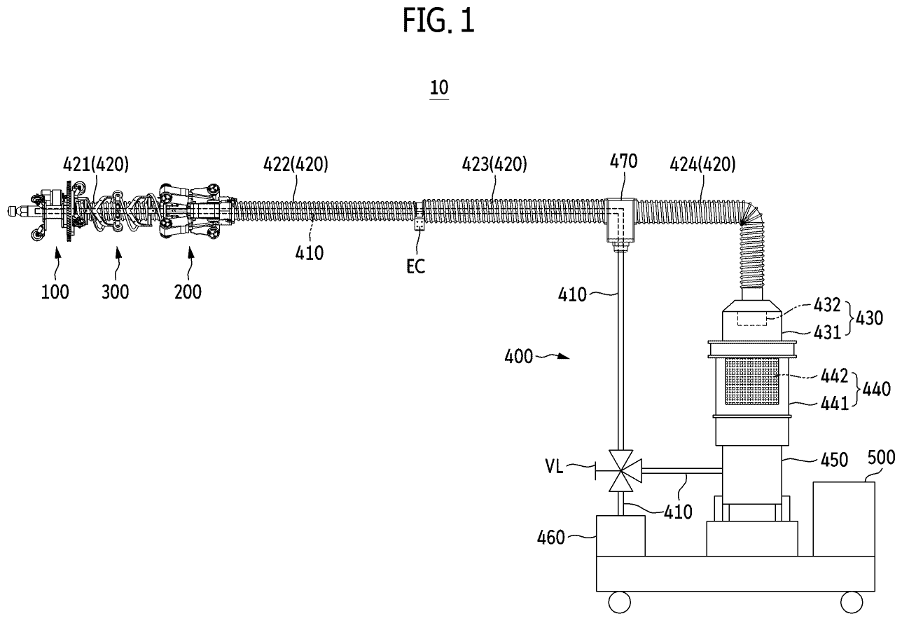

FIG. 1 is a diagram illustrating an apparatus for cleaning the interior of a pipe according to some embodiments of the present disclosure. Referring to FIG. 1, an apparatus 10 for cleaning the interior of a pipe may be configured to clean the interior of a pipe PP. The apparatus 10 may travel inside the pipe PP and inject a cleaning liquid into the pipe PP at a predetermined pressure to clean the interior of the pipe PP. The apparatus 10 may collect cleaning waste formed by the mixture of the cleaning liquid injected into the pipe PP and foreign matter AM inside the pipe PP. The apparatus 10 may collect the cleaning waste while preventing the cleaning waste from being discharged to the outside of the pipe PP. The apparatus 10 may filter the collected cleaning waste to regenerate the cleaning liquid from the cleaning waste and reuse the regenerated cleaning liquid to clean the interior of the pipe PP.

The apparatus 10 may clean the tube through which the cleaning waste has flowed after cleaning the interior of the pipe PP. The apparatus 10 may dry the interior of the cleaned pipe PP. The apparatus 10 may dry the interior of the cleaned pipe PP while traveling inside the cleaned pipe PP. The apparatus 10 may inject air into the cleaned pipe PP while traveling therein to dry the interior of the pipe PP.

For example, the apparatus 10 may clean the interior of a pipe PP connected to a facility such as a scrubber used in semiconductor manufacturing processes, in which by-products generated in the semiconductor manufacturing processes are accumulated in the form of sludge. However, the pipe PP to be cleaned by the apparatus 10 is not particularly limited.

Referring to FIG. 1, the apparatus 10 may include a cleaning unit 100, a traveling unit 200, a flexible connection unit 300, a collection and regeneration unit 400, and a controller 500.

The cleaning unit 100 may clean the interior of the pipe PP. The cleaning unit 100 may inject a cleaning liquid into the pipe PP at a predetermined pressure to clean the interior of the pipe PP. Therefore, even if sludge-type foreign matter AM are present inside the pipe PP, the cleaning unit 100 may clean the interior of the pipe PP. The cleaning unit 100 may be configured to travel in a first direction inside the pipe PP while injecting the cleaning liquid at a predetermined pressure. The first direction may be a direction in which the cleaning unit 100 moves toward the location where the foreign matter AM are present inside the pipe PP. The first direction may be referred to as a cleaning direction. In example embodiments, the first direction may be a direction parallel to a central axis that runs lengthwise through the pipe PP.

Due to the cleaning liquid injected from the cleaning unit 100, the foreign matter AM inside the pipe PP may flow along with the cleaning liquid, thereby allowing the interior of the pipe PP to be cleaned. In addition, the pressure of the cleaning liquid injected from the cleaning unit 100 may separate the foreign matter AM adhered to the inner wall of the pipe PP, and the separated foreign matter AM may flow along with the cleaning liquid, thereby cleaning the interior of the pipe PP.

For example, the cleaning liquid injected from the cleaning unit 100 may be water. In other words, the cleaning liquid injected from the cleaning unit 100 may be cleaning water. However, the cleaning liquid injected from the cleaning unit 100 is not limited to water and may include, for example, a detergent mixed with water.

The cleaning unit 100 may inject the cleaning liquid at an angle between a direction perpendicular to the first direction and a second direction opposite to the first direction. The direction perpendicular to the first and second directions may be a radial direction. For example, the direction perpendicular to the first and second directions may be a direction perpendicular to the central axis of the pipe PP. In this case, the cleaning unit 100 may travel in the first direction inside the pipe PP by the injection of the cleaning liquid into the pipe PP, without relying on the traveling unit 200. In other words, even if the apparatus 10 does not include the traveling unit 200, the cleaning unit 100 may inject the cleaning liquid at an angle between the direction perpendicular to the first direction and the second direction to travel in the first direction inside the pipe PP.

A case where the cleaning unit 100 travels inside the pipe PP through the injection of the cleaning liquid without relying on the traveling unit 200 may be referred to as a first traveling state. In addition, a case where the cleaning unit 100 travels inside the pipe PP via the traveling unit 200 may be referred to as a second traveling state. The pressure of the cleaning liquid injected from the cleaning unit 100 in the first traveling state may differ from that in the second traveling state. If the pressure of the cleaning liquid injected from the cleaning unit 100 in the first traveling state is referred to as a first injection pressure and the pressure of the cleaning liquid injected from the cleaning unit 100 in the second traveling state is referred to as a second injection pressure, the first injection pressure may be higher than the second injection pressure.

The cleaning unit 100 may inject the cleaning liquid in the direction perpendicular to the first direction. When the cleaning unit 100 injects the cleaning liquid in a direction perpendicular to the first direction, the cleaning unit 100 may travel in the first direction inside the pipe PP via the traveling unit 200. In other words, when the cleaning unit 100 injects the cleaning liquid in the direction perpendicular to the first direction, it may not be able to travel inside the pipe PP in the first traveling state.

The cleaning waste, formed by the mixture of the cleaning liquid injected into the pipe PP and the foreign matter AM inside the pipe PP, may be collected by the collection and regeneration unit 400 through the cleaning unit 100.

Meanwhile, after cleaning the interior of the pipe PP, a waste collection tube 420, which will be described later and is included in the collection and regeneration unit 400, through which the cleaning waste has flowed, may be cleaned by the cleaning liquid injected from the cleaning unit 100. In addition, the cleaning unit 100 may dry the interior of the cleaned pipe PP. The cleaning unit 100 may travel in the second direction after cleaning the interior of the pipe PP and remove the cleaning liquid on the inner wall of the cleaned pipe PP by means of waste flow blocking members 122, which are included in the cleaning unit 100 and will be described later. The cleaning unit 100 may also inject air into the interior of the cleaned pipe PP while traveling in the second direction to dry the interior of the cleaned pipe PP. Since the interior of the cleaned pipe PP is dried while the cleaning unit 100 travels in the second direction, the second direction may be referred to as a drying direction. When the cleaning unit 100 has traveled inside the pipe PP in the first traveling state, the cleaning unit 100 may be made to travel in the second direction inside the pipe PP by a worker or the like.

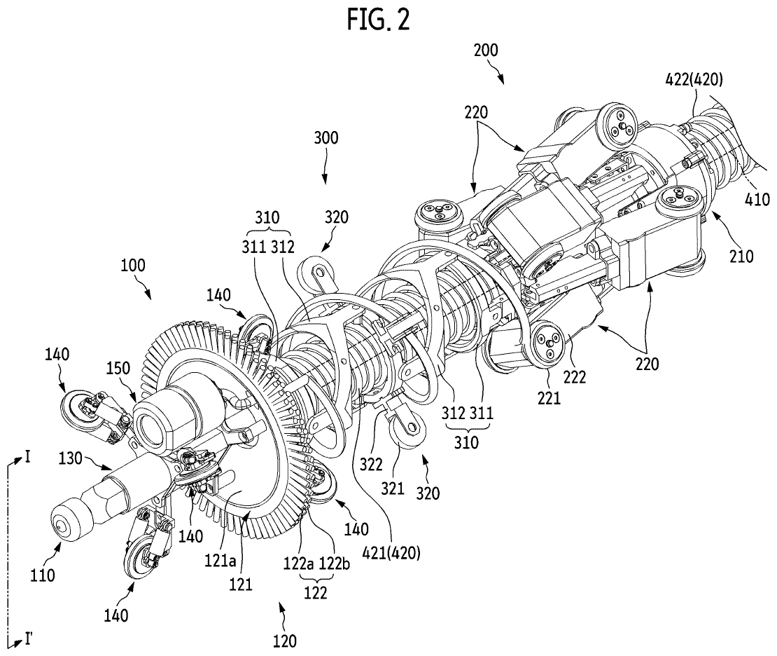

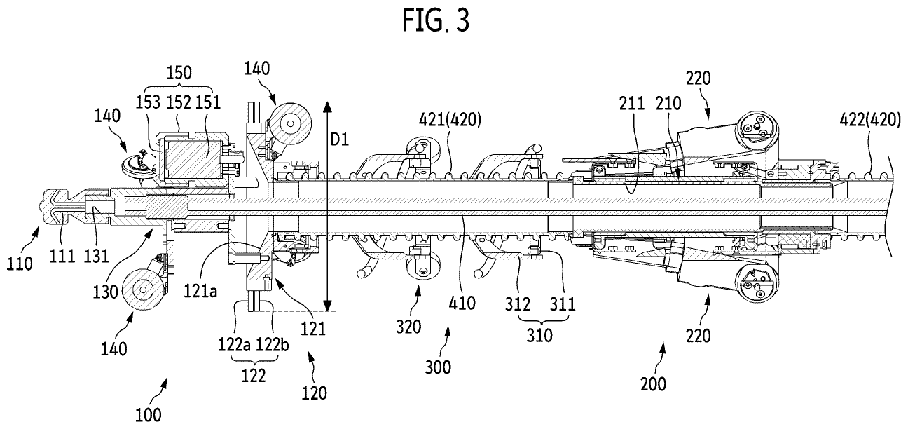

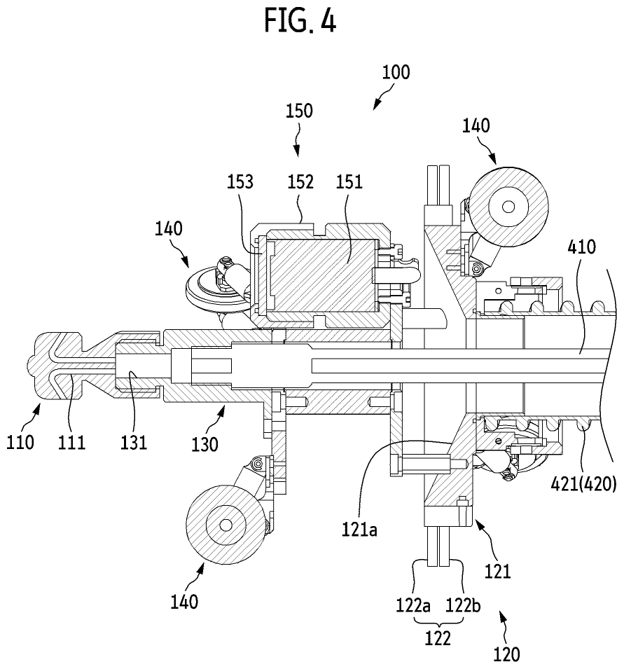

FIG. 2 is a perspective view illustrating the cleaning unit, the flexible connection units, and the traveling unit of the apparatus of FIG. 1, FIG. 3 is a cross-sectional view taken along line I-I′ in FIG. 2, and FIG. 4 is an enlarged cross-sectional view of the cleaning unit in FIG. 3.

Referring to FIGS. 2 through 4, along with FIG. 1, the cleaning unit 100 may include a spray nozzle 110, a waste collection guide unit 120, a nozzle support member 130, nozzle centering units 140, and a pipe interior imaging unit 150.

The spray nozzle 110 may inject a cleaning liquid into the interior of the pipe PP. When the cleaning unit 100 travels in the first direction inside the pipe PP, the cleaning liquid may be sprayed from the spray nozzle 110, thereby cleaning the interior of the pipe PP. The spray nozzle 110 may inject air into the cleaned interior of the pipe PP. When the cleaning unit 100 travels in the second direction inside the pipe PP, air may be sprayed from the spray nozzle 110, thereby drying the cleaned interior of the pipe PP.

A fluid supply tube 410, which is included in the collection and regeneration unit 400 and will be described later, may be connected to the spray nozzle 110. For example, the fluid supply tube 410 may be fluidly connected to the spray nozzle 110. The cleaning liquid or air may be supplied to the spray nozzle 110 through the fluid supply tube 410. The fluid supply tube 410 may be connected to the spray nozzle 110 via the nozzle support member 130. In other words, the spray nozzle 110 may be connected to the nozzle support member 130, and the fluid supply tube 410 may be connected to the nozzle support member 130 to which the spray nozzle 110 is connected, so that the fluid supply tube 410 may be connected to the spray nozzle 110. However, the fluid supply tube 410 may also be directly connected to the spray nozzle 110.

A spray flow passage 111 may be formed in the spray nozzle 110. The cleaning liquid or air supplied to the spray nozzle 110 through the fluid supply tube 410 of the collection and regeneration unit 400 may flow through the spray flow passage 111 and may be sprayed into the pipe PP. One end of the spray flow passage 111 may be open to the outside of the spray nozzle 110, and the other end of the spray flow passage 111 may be connected to the fluid supply tube 410 via the nozzle support member 130 or directly connected to the fluid supply tube 410. The end of the spray flow passage 111 that is open to the outside of the spray nozzle 110 may be formed at an angle between the direction perpendicular to the first direction and the second direction. Alternatively, one end of the spray flow passage 111 may be formed in the spray nozzle 110 in the direction perpendicular to the first direction. The spray flow passage 111 may provide one or more flow paths through which fluids, including gases and liquids, may flow from the fluid supply tube 410 to an outside of the spray nozzle 110.

Around the spray nozzle 110, the cleaning liquid or air may be sprayed at an angle between the direction perpendicular to the first direction and the second direction, or in the direction perpendicular to the first direction. As a result, the entire interior of the pipe PP may be cleaned with the cleaning liquid without any uncleaned areas. In addition, after the interior of the pipe PP is cleaned with the cleaning liquid, the entire interior of the pipe PP may be dried with air without any undried areas. To enable the cleaning liquid or air to be sprayed around the spray nozzle 110, a plurality of spray flow passage 111 may be provided. The plurality of spray flow passage 111 may be formed in the spray nozzle 110 to be spaced apart from each other in the circumferential direction of the spray nozzle 110. Alternatively, a single spray flow passage 111 may branch into a plurality of paths spaced apart in the circumferential direction of the spray nozzle 110, so that the cleaning liquid or air may be sprayed around the spray nozzle 110.

Meanwhile, the spray nozzle 110 may be configured to rotate by the reaction force generated when the cleaning liquid is sprayed, similarly to a rotary sprinkler that rotates due to the reaction force when water is sprayed.

The waste collection guide unit 120 may guide the cleaning waste inside the pipe PP so that the cleaning waste is not discharged to the outside of the pipe PP through the pipe PP, but instead flows into the waste collection tube 420 of the collection and regeneration unit 400 and is then collected. The waste collection tube 420 may be connected to the waste collection guide unit 120. For example, the waste collection tube 420 may be fluidly connected to the waste collection guide unit 120. The cleaning waste guided by the waste collection guide unit 120 may flow into the waste collection tube 420 and flow along the waste collection tube 420. The cleaning waste that has flowed through the waste collection tube 420 may be collected in a waste collector 430, which is included in the collection and regeneration unit 400 and will be described later.

The waste collection guide unit 120 may support the nozzle support member 130 and portions of a plurality of nozzle centering units 140. In other words, the nozzle support member 130 and the portions of the plurality of nozzle centering units 140 may be connected to and thereby supported by the waste collection guide unit 120. The waste collection guide unit 120 may include a collection guide member 121 and the waste flow blocking members 122.

The collection guide member 121 may guide the cleaning waste inside the pipe PP to flow into the waste collection tube 420 of the collection and regeneration unit 400. A collection guide flow passage 121a may be formed in the collection guide member 121. One end of the collection guide flow passage 121a may be open so that cleaning waste inside the pipe PP may flow into the collection guide flow passage 121a. In addition, the other end of the collection guide flow passage 121a may be connected to the waste collection tube 420, so that the cleaning waste guided through the collection guide flow passage 121a may flow into the waste collection tube 420. For example, the other end of the collection guide flow passage 121a may be connected to a first waste collection tube 421, which is included in the waste collection tube 420 and will be described later.

One end of the collection guide flow passage 121a may be referred to as a waste inlet side, and the other end of the collection guide flow passage 121a may be referred to as a waste outlet side. The collection guide flow passage 121a may have a shape that allows cleaning waste to easily flow into the waste inlet side. The cross-sectional size of the waste inlet side of the collection guide flow passage 121a in the direction perpendicular to the first direction may be greater than the cross-sectional size of the waste outlet side of the collection guide flow passage 121a in the direction perpendicular to the first direction. In addition, at least a portion of the collection guide flow passage 121a may have a cross section perpendicular to the first direction that increases toward the waste inlet side. For example, the collection guide flow passage 121a may have a frustoconical shape, but the shape of the collection guide flow passage 121a is not particularly limited.

The collection guide member 121 may support the nozzle support member 130 and portions of the plurality of nozzle centering units 140. In other words, the nozzle support member 130 and the portions of the plurality of nozzle centering units 140 may be connected to and thereby supported by the collection guide member 121.

Meanwhile, after the pipe PP is cleaned with the cleaning liquid, the cleaning liquid may be sprayed into the pipe PP through the spray nozzle 110 in order to clean the interior of the waste collection tube 420 of the collection and regeneration unit 400. The cleaning liquid sprayed into the pipe PP through the spray nozzle 110 may flow into the waste collection tube 420 through the collection guide flow passage 121a of the collection guide member 121. In addition, any cleaning waste remaining in the waste collection tube 420 may flow along the waste collection tube 420 together with the cleaning liquid and may be collected in the waste collector 430 of the collection and regeneration unit 400. Thus, the interior of the waste collection tube 420 may be cleaned.

The waste flow blocking members 122 may block cleaning waste from passing between the collection guide member 121 and the inner wall of the pipe PP and flowing through the pipe PP during the cleaning of the interior of the pipe PP with the cleaning liquid. This may prevent the cleaning waste from being discharged to the outside of the pipe PP through the pipe PP during the cleaning of the interior of the pipe PP. Furthermore, the exposure of cleaning waste containing toxic substances to workers due to discharge through the pipe PP may be prevented. In addition, harm to workers or damage to facilities FT due to the exposure of toxic cleaning waste may be prevented. Accordingly, the cleaning operation for the interior of the pipe PP may be performed safely.

The waste flow blocking members 122 may be connected to the circumference of the collection guide member 121 so as to be positioned between the collection guide member 121 and the inner wall of the pipe PP. For example, the waste flow blocking members 122 may each include one or more of a brush, sponge, rubber, or fabric. In a case where each of the waste flow blocking members 122 includes a brush, the brush may include a plurality of brush bristles, but the waste flow blocking members 122 are not particularly limited. A plurality of waste flow blocking members 122 may be provided. The plurality of waste flow blocking members 122 may be connected to the circumference of the collection guide member 121 to be adjacent to one another in the circumferential direction of the collection guide member 121. The plurality of waste flow blocking members 122 may at least partially overlap with one another in the circumferential direction of the collection guide member 121.

For example, the waste flow blocking members 122 may include first waste flow blocking members 122a and second waste flow blocking members 122b. A plurality of first waste flow blocking members 122a may be connected to the circumference of the collection guide member 121 to be adjacent to one another in the circumferential direction of the collection guide member 121. A plurality of second waste flow blocking members 122b may also be connected to the circumference of the collection guide member 121 to be adjacent to one another in the circumferential direction of the collection guide member 121. The plurality of second waste flow blocking members 122b may be arranged to the rear of the plurality of first waste flow blocking members 122a in the first direction, and each of the plurality of second waste flow blocking members 122b may be positioned between adjacent first waste flow blocking members 122a. In addition, each of the plurality of second waste flow blocking members 122b may at least partially overlap, in the first direction, with the first waste flow blocking members 122a positioned on both sides thereof in the circumferential direction of the collection guide member 121. However, the arrangement in which the plurality of waste flow blocking members 122 are connected to the circumference of the collection guide member 121 to be positioned between the collection guide member 121 and the inner wall of the pipe PP is not particularly limited.

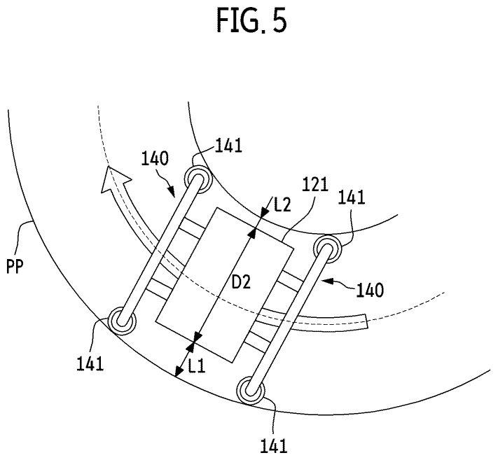

FIG. 5 is a schematic view illustrating an arrangement in which the collection guide member of the waste collection guide unit of the apparatus of FIG. 1 is arranged inside a curved pipe.

For example, FIG. 5 illustrates a plurality of centering wheels 141 may be in contact with the inner wall of the pipe PP when the cleaning unit 100 travels inside the pipe PP. As shown in FIG. 5, each of the plurality of centering wheels 141 may maintain contact with the inside of the pipe PP when the cleaning unit 100 travels inside the pipe PP.

Referring to FIG. 5, since examples of the pipe PP may include not only a straight pipe but also a curved pipe, the cleaning unit 100 may travel not only inside a straight pipe PP but also inside a curved pipe PP. When the cleaning unit 100 travels inside the curved pipe PP, the distance between the collection guide member 121 of the waste collection guide unit 120 and the inner wall of the curved pipe PP on the radially outer side of the curved pipe PP may be referred to as a distance L1. In addition, when the cleaning unit 100 travels inside the curved pipe PP, the distance between the collection guide member 121 and the inner wall of the curved pipe PP on the radially inner side of the curved pipe PP may be referred to as a distance L2. Here, the distance L1 may be greater than the distance L2.

The diameter of the waste collection guide unit 120 may be referred to as a diameter D1, and the diameter of the collection guide member 121 may be referred to as a diameter D2. To block the cleaning waste from passing between the collection guide member 121 and the inner wall of the curved pipe PP and flowing through the pipe PP while the cleaning unit 100 travels inside the curved pipe PP, the diameter D1 may need to be greater than the sum of the diameter D2 and twice the distance L1. In other words, in order for the waste flow blocking members 122 to block the cleaning waste, even within the curved pipe PP, from passing between the collection guide member 121 and the inner wall of the curved pipe PP and flowing through the curved pipe PP, the following Equation 1 may need to be satisfied.

D1>D2+(2×L1) [Equation 1]

The waste flow blocking members 122 may have a length that satisfies Equation 1 in the radial direction of the collection guide member 121. For example, the waste flow blocking members 122 may have a length greater than the distance L1 in the radial direction of the collection guide member 121. For example, each of the first waste flow blocking members 122a and the second waste flow blocking members 122b may have a length greater than the distance L1 in the radial direction of the collection guide member 121.

Referring again to FIGS. 2 through 4, the nozzle support member 130 may support the spray nozzle 110. The nozzle support member 130 may be connected to and supported by the waste collection guide unit 120. The nozzle support member 130 may be connected to and supported by the collection guide member 121 of the waste collection guide unit 120. In addition, the spray nozzle 110 may be detachably connected to the nozzle support member 130 so that the nozzle support member 130 may support the spray nozzle 110. Since the spray nozzle 110 is detachably connected to the nozzle support member 130, the spray nozzle 110 may be replaceable. In other words, the spray nozzle 110 may be replaced with another spray nozzle 110 having a suitable size or spray angle for cleaning the interior of the pipe PP to be cleaned. The spray nozzle 110 may be detachably connected to the nozzle support member 130 by threaded engagement, but the detachable connection of the spray nozzle 110 to the nozzle support member 130 is not particularly limited.

The fluid supply tube 410 of the collection and regeneration unit 400 may be connected to the nozzle support member 130 to be connected to the spray nozzle 110. In other words, the spray nozzle 110 and the fluid supply tube 410 may be connected via the nozzle support member 130. The nozzle connection hole 131 may be formed in the nozzle support member 130. The spray nozzle 110 may be detachably connected to one end of the nozzle connection hole 131, and the fluid supply tube 410 may be connected to the other end of the nozzle connection hole 131. For example, the spray nozzle 110 may be fluidly connected to the fluid supply tube 410 via the nozzle connection hole 131 of the nozzle support member 130.

The nozzle support member 130 may support portions of the plurality of nozzle centering units 140. In other words, portions of the plurality of nozzle centering units 140 may be connected to and supported by the nozzle support member 130. The nozzle support member 130 may support the pipe interior imaging unit 150. In other words, the pipe interior imaging unit 150 may be connected to and supported by the nozzle support member 130.

The nozzle centering units 140 may support the spray nozzle 110 so that the spray nozzle 110 is positioned at the center of the interior of the pipe PP. A plurality of nozzle centering units 140 may be provided. For example, there may be at least three or more nozzle centering units 140. Some of the plurality of nozzle centering units 140 may be connected to the nozzle support member 130 to which the spray nozzle 110 is connected, thereby supporting the spray nozzle 110 so that the spray nozzle 110 is positioned at the center of the interior of the pipe PP. In addition, some of the plurality of nozzle centering units 140 may be connected to the collection guide member 121 of the waste collection guide unit 120, to which the nozzle support member 130 is connected, thereby supporting the spray nozzle 110 so that the spray nozzle 110 is positioned at the center of the interior of the pipe PP.

For example, there may be six nozzle centering units 140. Among the six nozzle centering units 140, three nozzle centering units 140 may be connected to the nozzle support member 130 to which the spray nozzle 110 is connected, and may support the spray nozzle 110 so that the spray nozzle 110 is positioned at the center of the interior of the pipe PP. The three nozzle centering units 140 connected to the nozzle support member 130 may be spaced apart from one another at 120-degree intervals in the circumferential direction of the nozzle support member 130. In addition, the other three nozzle centering units 140 may be connected to the collection guide member 121 of the waste collection guide unit 120, to which the nozzle support member 130 is connected, and may support the spray nozzle 110 so that the spray nozzle 110 is positioned at the center of the interior of the pipe PP. The three nozzle centering units 140 connected to the collection guide member 121 may be spaced apart from one another at 120-degree intervals in the circumferential direction of the collection guide member 121. Each of the three nozzle centering units 140 connected to the collection guide member 121 may be positioned between adjacent nozzle centering units 140 connected to the nozzle support member 130. The six nozzle centering units 140 may be spaced apart from one another at 60-degree intervals in the circumferential direction of the cleaning unit 100. However, the number and spacing of the nozzle centering units 140 are not particularly limited.

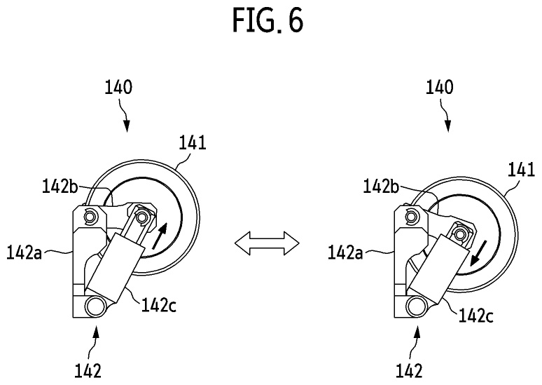

FIG. 6 illustrates enlarged views of one of the nozzle centering units of the cleaning unit of FIG. 4.

Referring to FIG. 6, a nozzle centering unit 140 may include a centering wheel 141 and a centering wheel support 142.

The centering wheel 141 may be in at least partial contact with the inner wall of the pipe PP when the cleaning unit 100 travels inside the pipe PP.

The centering wheel support 142 may be connected to the cleaning unit 100. The centering wheel support 142 may be connected to the nozzle support member 130 to which the spray nozzle 110 is connected or to the collection guide member 121 of the waste collection guide unit 120 to which the nozzle support member 130 is connected.

The centering wheel support 142 may rotatably support the centering wheel 141. The centering wheel 141 may be rotatably arranged on the centering wheel support 142, so that the centering wheel support 142 may rotatably support the centering wheel 141. The centering wheel support 142 may elastically support the centering wheel 141. Even when there is an obstacle on the inner wall of the pipe PP, such as an uneven surface or a step or gap at a pipe connection, the centering wheel support 142 may rotatably support the centering wheel 141. Also, even when there is an obstacle on the inner wall of the pipe PP, the nozzle centering unit 140 may support the spray nozzle 110 such that the spray nozzle 110 is positioned at the center inside the pipe PP.

For example, the centering wheel support 142 may include a first link 142a, a second link 142b, and an elastic support piston 142c. The first link 142a may be connected to the nozzle support member 130 or to the collection guide member 121 of the waste collection guide unit 120 to which the nozzle support member 130 is connected. The second link 142b may be rotatably connected to the first link 142a, and the centering wheel 141 may be rotatably arranged on the second link 142b. The elastic support piston 142c may be connected to the first and second links 142a and 142b, and may include an elastic member (not illustrated) such as a spring to elastically support the second link 142b on which the centering wheel 141 is rotatably arranged. However, the configurations of the elastic support piston 142c and the centering wheel support 142 are not particularly limited.

The nozzle centering unit 140 may further include a centering wheel drive motor (not illustrated) that is connected to the centering wheel 141 and provides rotational force for rotating the centering wheel 141. The centering wheel drive motor may be connected to and controlled by the controller 500. For example, the centering wheel drive motor may be communicatively coupled to the controller 500. When the centering wheel 141 is rotated by driving the centering wheel drive motor, the cleaning unit 100 may travel inside the pipe PP in the first direction or the second direction. If the nozzle centering unit 140 includes the centering wheel drive motor, the apparatus 10 may not include the traveling unit 200.

Referring again to FIGS. 2 through 4, the pipe interior imaging unit 150 may capture an image of the interior of the pipe PP. The pipe interior imaging unit 150 may include a camera 151, a camera housing 152, and an imaging window 153.

The camera 151 may capture an image of the interior of the pipe PP. The camera 151 may be connected to the controller 500 and transmit a captured image of the interior of the pipe PP to the controller 500. For example, the camera 151 may be communicatively coupled to the controller 500. The controller 500 may include or be connected to a display (not illustrated). The controller 500 may display the image of the interior of the pipe PP captured by the camera 151 on the display. An operator may view the image of the interior of the pipe PP captured by the camera 151 via the display. The operator may check the condition inside the pipe PP by viewing the image captured by the camera 151 via the display. The operator may check the contamination state of the interior of the pipe PP caused by foreign matter AM, the cleaning state of the interior of the pipe PP due to spray of the cleaning liquid, or the drying state of the interior of the pipe PP due to air injection, by viewing the image captured by the camera 151 via the display.

The camera housing 152 may support the camera 151 and protect the camera 151 from the foreign matter AM, cleaning waste, and cleaning liquid inside the pipe PP. An internal space with one open side may be formed in the camera housing 152. The camera 151 may be disposed in the internal space of the camera housing 152 through the open side. With the camera 151 disposed in the internal space of the camera housing 152, the camera housing 152 may support and protect the camera 151. The camera 151 may be arranged in the internal space of the camera housing 152 to face the interior of the pipe PP. The open side of the internal space of the camera housing 152 may be sealed with an imaging window 153. The camera housing 152 may be supported by the nozzle support member 130. In other words, the camera housing 152 may be connected to and supported by the nozzle support member 130.

The imaging window 153 may be connected to the open side of the internal space of the camera housing 152 and may seal the open side of the internal space of the camera housing 152. The imaging window 153 may be transparent so that the camera 151 may capture an image of the interior of the pipe PP. The imaging window 153 may be cleaned by the cleaning liquid sprayed from the spray nozzle 110. To enable such cleaning, the imaging window 153 may be positioned behind the spray nozzle 110 in the first direction.

Although not illustrated, the cleaning unit 100 may further include additional cleaning equipment such as a rotating brush, a blade, or a scraper to enhance the cleaning capability for the interior of the pipe PP.

The traveling unit 200 may allow the cleaning unit 100 to travel inside the pipe PP in the first direction or the second direction. The traveling unit 200 may be detachably connected to the cleaning unit 100. The traveling unit 200 may be detachably connected to the flexible connection unit 300, which is detachably connected to the cleaning unit 100. However, the traveling unit 200 may also be detachably connected directly to the cleaning unit 100. In other words, in some embodiments, the apparatus 10 may include the traveling unit 200 but not the flexible connection unit 300.

If the cleaning unit 100 travels inside the pipe PP in the first traveling state, the traveling unit 200 may not be necessary. Likewise, when the cleaning unit 100 travels inside the pipe PP by rotating the centering wheels 141 of the nozzle centering units 140 via the centering wheel drive motors, the traveling unit 200 may also not be necessary. In such cases, the apparatus 10 may not include the traveling unit 200, and the traveling unit 200 may be separated from the cleaning unit 100.

Since the traveling unit 200 may be detachably connected to the cleaning unit 100, it may be possible to replace the traveling unit 200 with another traveling unit 200 that has a suitable size, shape, or configuration for the interior of the pipe PP to be cleaned.

The fluid supply tube 410 of the collection and regeneration unit 400 may pass through the traveling unit 200. Also, the waste collection tube 420 of the collection and regeneration unit 400 may be connected to the traveling unit 200.

The traveling unit 200 may include a traveling unit body 210 and traveling drivers 220.

The traveling unit body 210 may be detachably connected to the cleaning unit 100. The traveling unit body 210 may be detachably connected to the flexible connection unit 300, which is detachably connected to the cleaning unit 100. The traveling unit body 210 may be detachably connected to one of a plurality of flexible connection members 310, which will be described later, included in the flexible connection unit 300. However, if the flexible connection unit 300 is unnecessary and the apparatus 10 does not include the flexible connection unit 300, the traveling unit body 210 may be directly detachably connected to the cleaning unit 100. In this case, the traveling unit body 210 may be detachably connected to the collection guide member 121 of the cleaning unit 100.

For example, although not illustrated, the traveling unit body 210 may be detachably connected to one of the plurality of flexible connection members 310 of the flexible connection unit 300 by a bolt or the like, but the present disclosure is not limited thereto. For example, although not illustrated, the traveling unit body 210 may also be detachably connected to the collection guide member 121 of the cleaning unit 100 by a connection bracket or the like, but the present disclosure is not limited thereto.

The traveling unit body 210 may support the traveling drivers 220. The traveling drivers 220 may be connected to the traveling unit body 210, and the traveling unit body 210 may support the traveling drivers 220.

A waste flow passage 211 may be formed in the traveling unit body 210. The fluid supply tube 410 of the collection and regeneration unit 400 may pass through the waste flow passage 211, and the waste collection tube 420 of the collection and regeneration unit 400 may be detachably connected to the waste flow passage 211. For example, a first waste collection tube 421 of the waste collection tube 420 may be detachably connected to one end of the waste flow passage 211, and a second waste collection tube 422, which is included in the waste collection tube 420 and will be described later, may be detachably connected to the other end of the waste flow passage 211.

The traveling drivers 220 may provide driving force for the cleaning unit 100 to travel inside the pipe PP. The traveling drivers 220 may be connected to the traveling unit body 210. A plurality of traveling drivers 220 may be provided. For example, there may be at least three or more traveling drivers 220.

For example, three traveling drivers 220 may be connected to the front side of the traveling unit body 210 in the first direction, and three traveling drivers 220 may be connected to the rear side of the traveling unit body 210. The three traveling drivers 220 connected to the front side of the traveling unit body 210 may be spaced apart at 120-degree intervals in the circumferential direction of the traveling unit body 210. The three traveling drivers 220 connected to the rear side of the traveling unit body 210 may also be spaced apart at 120-degree intervals in the circumferential direction of the traveling unit body 210. Each of the three traveling drivers 220 connected to the rear side of the traveling unit body 210 may be positioned between the three front traveling drivers 220 connected to the front side of the traveling unit body 210. The six traveling drivers 220 may be spaced apart at 60-degree intervals in the circumferential direction of the traveling unit body 210. However, the number and spacing of the traveling drivers 220 are not particularly limited.

Each of the traveling drivers 220 may include traveling wheels 221 and a traveling wheel driver 222.

At least portions of the traveling wheels 221 may be in contact with the inner wall of the pipe PP. The traveling wheels 221 may be rotatably arranged on the traveling wheel driver 222. Two traveling wheels 221 may be rotatably arranged on the traveling wheel driver 222. For example, one traveling wheel driver 222 may drive two traveling wheels 221 that are arranged on the traveling wheel driver 222. However, the number of traveling wheels 221 rotatably arranged on the traveling wheel driver 222 is not particularly limited.

The traveling wheel driver 222 may provide rotational force to rotate the traveling wheels 221. The traveling wheels 221 may be rotatably arranged on the traveling wheel driver 222. The traveling wheel driver 222 may include a traveling wheel drive motor (not illustrated) connected to the rotation shafts of the traveling wheels 221. The traveling wheel driver 222 may be connected to and controlled by the controller 500. The traveling wheel drive motor of the traveling wheel driver 222 may be connected to and controlled by the controller 500. For example, the traveling wheel driver 222 and the traveling wheel drive motor each may be communicatively coupled to the controller 500. The traveling wheel driver 222 and the traveling wheel drive motor may provide driving force to cause the cleaning unit 100 to travel inside the pipe PP.

The flexible connection unit 300 may flexibly connect the cleaning unit 100 and the traveling unit 200. As the flexible connection unit 300 flexibly connects the cleaning unit 100 and the traveling unit 200, when the cleaning unit 100 travels inside the pipe PP via the traveling unit 200, the cleaning unit 100 may also travel through the interior of the pipe PP even if the pipe PP is a curved pipe. In other words, the flexible connection unit 300 may be flexibly deformable according to the shape of the pipe PP. Furthermore, when the cleaning unit 100 travels inside the pipe PP via the traveling unit 200, the flexible connection unit 300 may be flexibly deformable according to the shape of the pipe PP, so that the cleaning unit 100 may travel through the interior of the pipe PP even if the pipe PP is a curved pipe.

The flexible connection unit 300 may be detachably connected to the cleaning unit 100 and the traveling unit 200. The flexible connection unit 300 may be detachably connected to the waste collection guide unit 120 of the cleaning unit 100. Additionally, the flexible connection unit 300 may be detachably connected to the traveling unit body 210 of the traveling unit 200. Since the flexible connection unit 300 is detachably connected to the cleaning unit 100 and the traveling unit 200, when the flexible connection unit 300 is unnecessary, the flexible connection unit 300 may be detached from the cleaning unit 100 and the traveling unit 200, and the traveling unit 200 may be directly connected to the cleaning unit 100.

The waste collection tube 420 of the collection and regeneration unit 400, in which the fluid supply tube 410 of the collection and regeneration unit 400 is disposed, may pass through the flexible connection unit 300. The waste collection tube 420 that has passed through the flexible connection unit 300 may be connected to the cleaning unit 100. The waste collection tube 420 that has passed through the flexible connection unit 300 may be connected to the collection guide member 121 of the cleaning unit 100. For example, the first waste collection tube 421 of the waste collection tube 420 may pass through the flexible connection unit 300. Since the fluid supply tube 410 and the waste collection tube 420 are also flexible like the flexible connection unit 300, the fluid supply tube 410 and the waste collection tube 420 may be deformed according to the shape of the pipe PP, like the flexible connection unit 300 that is deformable according to the shape of the pipe PP.

The flexible connection unit 300 may include flexible connection members 310 and flexible connection member supports 320.

A plurality of flexible connection members 310 may be provided. The plurality of flexible connection members 310 may be flexibly connected to one another. The plurality of flexible connection members 310 may be rotatably and thereby flexibly connected to one another. Since the plurality of flexible connection members 310 are flexibly connected to one another, the flexible connection unit 300 may be flexibly deformable according to the shape of the pipe PP. The plurality of flexible connection members 310 may form a space through which the waste collection tube 420 of the collection and regeneration unit 400 passes.

One of the plurality of flexible connection members 310 may be detachably connected to the cleaning unit 100. One of the plurality of flexible connection members 310 may be detachably connected to the collection guide member 121 of the cleaning unit 100. Another of the plurality of flexible connection members 310 may be detachably connected to the traveling unit 200. Another of the plurality of flexible connection members 310 may be detachably connected to the traveling unit body 210 of the traveling unit 200. The flexible connection members 310 may be detachably connected to the collection guide member 121 or the traveling unit body 210 by bolts or the like. However, the arrangement in which the flexible connection members 310 are detachably connected to the collection guide member 121 or the traveling unit body 210 is not particularly limited.

For example, the flexible connection members 310 may include first flexible connection members 311 and second flexible connection members 312. A plurality of first flexible connection members 311 and a plurality of second flexible connection members 312 may be provided, and may be alternately arranged. The first flexible connection members 311 may have a ring shape. The first flexible connection member 311 arranged at one end of the array of the plurality of first flexible connection members 311 may be detachably connected to the collection guide member 121 of the cleaning unit 100. Additionally, the first flexible connection member 311 arranged at the other end of the array of the plurality of first flexible connection members 311 may be detachably connected to the traveling unit body 210 of the traveling unit 200. The second flexible connection members 312 may be connected to first flexible connection members 311 on one end thereof, may branch and rejoin while extending toward other first flexible connection members 311 at the other end thereof, and may be connected again to the other first flexible connection members 311. However, the configuration of the flexible connection members 310 is not particularly limited.

The flexible connection member supports 320 may each be connected to one of the plurality of flexible connection members 310 and may support the flexible connection members 310 inside the pipe PP. A plurality of flexible connection member supports 320 may be provided. The plurality of flexible connection member supports 320 may be spaced apart from each other in the circumferential direction of the flexible connection unit 300. For example, there may be four flexible connection member supports 320. The four flexible connection member supports 320 may be spaced apart from one another at 90° intervals in the circumferential direction of the flexible connection unit 300. However, the number and spacing of the flexible connection member supports 320 are not particularly limited.

The flexible connection member supports 320 may include support wheels 321 and wheel supports 322.

At least portions of the support wheels 321 may be in contact with the inner wall of the pipe PP. The wheel supports 322 may each be connected to one of the plurality of flexible connection members 310. For example, the wheel supports 322 may each be connected to one of the plurality of first flexible connection members 311. The support wheels 321 may be rotatably arranged on the wheel supports 322.

Referring to FIGS. 1 through 4, the collection and regeneration unit 400 may supply cleaning liquid to the cleaning unit 100. In addition, the collection and regeneration unit 400 may collect cleaning waste. Furthermore, the collection and regeneration unit 400 may regenerate the cleaning liquid from the collected cleaning waste by filtering the cleaning waste. The collection and regeneration unit 400 may supply the regenerated cleaning liquid to the cleaning unit 100. In other words, the collection and regeneration unit 400 may reuse the regenerated cleaning liquid for cleaning the interior of the pipe PP. Accordingly, the amount of cleaning liquid used for cleaning the interior of the pipe PP may be reduced. The collection and regeneration unit 400 may also supply air to the cleaning unit 100. The collection and regeneration unit 400 may include the fluid supply tube 410, the waste collection tube 420, the waste collector 430, a cleaning liquid tank 440, a cleaning liquid pump 450, an air supplier 460, and a tube branching connector 470.

The fluid supply tube 410 may provide a passage through which the cleaning liquid is supplied to the cleaning unit 100. In other words, during the cleaning of the interior of the pipe PP by the cleaning unit 100, the cleaning liquid may be supplied to the cleaning unit 100 through the fluid supply tube 410. The fluid supply tube 410 may also provide a passage through which air is supplied to the cleaning unit 100. For example, during the drying of the interior of the pipe PP by the cleaning unit 100, air may be supplied to the cleaning unit 100 through the fluid supply tube 410. The fluid supply tube 410 may be connected to the cleaning unit 100 to allow flow of the cleaning liquid or air to the cleaning unit 100. In addition, the fluid supply tube 410 may be connected to the cleaning liquid pump 450 and the air supplier 460 so that the cleaning liquid or air flows through the fluid supply tube 410.

One end of the fluid supply tube 410 may be connected to the spray nozzle 110 of the cleaning unit 100. One end of the fluid supply tube 410 may pass through the collection guide flow passage 121a of the collection guide member 121 of the cleaning unit 100, may be connected to the nozzle connection hole 131 of the nozzle support member 130 of the cleaning unit 100, and may be connected to the spray nozzle 110.

The other end of the fluid supply tube 410 may be connected to the cleaning liquid pump 450 and the air supplier 460. The other end of the fluid supply tube 410 may be connected to the cleaning liquid pump 450 and the air supplier 460 through a three-way valve VL. The three-way valve VL may connect the fluid supply tube 410 to either the cleaning liquid pump 450 or the air supplier 460. For example, the other end of the fluid supply tube 410 may include two segments extending from the three-way valve VL. The first segment of the fluid supply tube 410 may include one end connected to the three-way valve VL and the other end connected to the cleaning liquid pump 450, and the second segment of the fluid supply tube 410 may include one end connected to the three-way valve VL and the other end connected to the connected to the air supplier 460. The three-way valve VL may be connected to and controlled by the controller 500. For example, the three-way valve VL may be communicatively coupled to the controller 500. Additionally, the other end of the fluid supply tube 410 may branch to be connected to the cleaning liquid pump 450 and the air supplier 460. Also, a cleaning liquid supply valve (not illustrated), which is connected to and controlled by the controller 500, may be disposed at the portion of the fluid supply tube 410 connected to the cleaning liquid pump 450. Likewise, an air supply valve (not illustrated), which is connected to and controlled by the controller 500, may be disposed at the portion of the fluid supply tube 410 connected to the air supplier 460. For example, the cleaning liquid supply valve and the air supply valve each may be communicatively coupled to the controller 500.

The diameter of the fluid supply tube 410 may be smaller than the diameter of the waste collection tube 420. At least a portion of the fluid supply tube 410 may be disposed inside the waste collection tube 420. In other words, at least a portion of the fluid supply tube 410 may pass through the interior of the waste collection tube 420. For example, the fluid supply tube 410 may be disposed inside first, second, and third waste collection tubes 421, 422, and 423, which are included in the waste collection tube 420 and will be described later. Additionally, when the apparatus 10 includes the traveling unit 200, the fluid supply tube 410 may be disposed inside the waste flow passage 211 of the traveling unit body 210 of the traveling unit 200 to which the waste collection tube 420 is connected. In other words, the fluid supply tube 410 may pass through the waste flow passage 211 of the traveling unit body 210 to which the waste collection tube 420 is connected.

The fluid supply tube 410 may exit from the waste collection tube 420 at the tube branching connector 470 and may be connected to the cleaning liquid pump 450 and the air supplier 460. The fluid supply tube 410 may be flexibly deformable according to the shape of the pipe PP.

The waste collection tube 420 may provide a passage through which cleaning waste is collected. In other words, the cleaning waste may be collected through the waste collection tube 420. The waste collection tube 420 may be connected to the cleaning unit 100 so that the cleaning waste is collected through the cleaning unit 100. One end of the waste collection tube 420 may be connected to the waste collection guide unit 120 of the cleaning unit 100. One end of the waste collection tube 420 may be connected to the collection guide flow passage 121a of the collection guide member 121 of the waste collection guide unit 120. The other end of the waste collection tube 420 may be connected to the waste collector 430. The other end of the waste collection tube 420 may be connected to a collector body 431, which is included in the waste collector 430 and will be described later. For example, the other end of the waste collection tube 420 may be fluidly connected to the collector body 431.

The waste collection tube 420 may include a plurality of tubes. For example, when the apparatus 10 includes the traveling unit 200 and the flexible connection unit 300, the waste collection tube 420 may include the first, second, and third waste collection tubes 421, 422, and 423, and a fourth waste collection tube 424. The first waste collection tube 421 may be connected to the collection guide flow passage 121a of the cleaning unit 100 and to the waste flow passage 211 of the traveling unit 200. In addition, the second waste collection tube 422 may be connected to the traveling unit body 210 and to an extended connection flow path (not illustrated) formed in an extended connection member EC. The third waste collection tube 423 may be connected to the extended connection flow path of the extended connection member EC and to a branching flow path 471, which is formed in the tube branching connector 470 and will be described later. The fourth waste collection tube 424 may be connected to the branching flow path 471 and to the waste collector 430. For example, the first waste collection tube 421 may be fluidly connected to the second waste collection tube 422 through the traveling unit 200, the second waste collection tube 422 may be fluidly connected to the third waste collection tube 423 through the extended connection member EC, the third waste collection tube 423 may be fluidly connected to the fourth waste collection tube 424 through the tube branching connector 470, and the fourth waste collection tube 424 may be fluidly connected to the waste collector 430.

The length of the waste collection tube 420 may be adjusted by the extended connection member EC. For example, the length of the waste collection tube 420 may be increased by adding one or more additional extended connection members EC and one or more additional segments of the waste collection tube 420. However, the number of tubes included in the waste collection tube 420 is not particularly limited and may vary depending on whether the apparatus 10 includes the traveling unit 200 or the flexible connection unit 300. The waste collection tube 420 may be flexibly deformable according to the shape of the pipe PP.

The waste collector 430 may collect the cleaning waste. The waste collector 430 may collect the cleaning waste through the waste collection tube 420. The waste collection tube 420 may be connected to the waste collector 430 so that the cleaning waste is collected. For example, the fourth waste collection tube 424 of the waste collection tube 420 may be connected to the waste collector 430. The waste collector 430 may include the collector body 431 and a suction device 432.

The collector body 431 may provide a space in which the cleaning waste is collected. The cleaning waste that has flowed through the waste collection tube 420 may be collected in the internal space of the collector body 431. The waste collection tube 420 may be connected to the collector body 431. For example, the fourth waste collection tube 424 of the waste collection tube 420 may be connected to the collector body 431.

The suction device 432 may provide suction force so that the cleaning waste is collected in the collector body 431 through the waste collection tube 420. The suction device 432 may include a suction fan (not illustrated) and a suction fan driving motor (not illustrated). The suction fan may be rotatably mounted in the internal space of the collector body 431. The suction fan driving motor may be connected to the suction fan and may provide rotational force to the suction fan. The suction fan driving motor may be connected to and controlled by the controller 500. For example, the suction fan driving motor may be communicatively coupled to the controller 500.

The cleaning liquid tank 440 may provide a space in which the cleaning liquid is stored. The cleaning liquid tank 440 may store the cleaning liquid to be supplied to the cleaning unit 100. In addition, the cleaning waste collected in the waste collector 430 may be filtered in the cleaning liquid tank 440 so that the cleaning liquid is regenerated from the cleaning waste. The regenerated cleaning liquid may be stored in the cleaning liquid tank 440. The cleaning liquid tank 440 may include a tank body 441 and a waste filter 442.

The tank body 441 may provide a space in which the cleaning liquid is stored. The cleaning liquid may be stored in the internal space of the tank body 441. The tank body 441 may be connected to the waste collector 430 and the cleaning liquid pump 450. The upper portion of the tank body 441 may be connected to the lower portion of the collector body 431 of the waste collector 430. In addition, the lower portion of the tank body 441 may be connected to the upper portion of the cleaning liquid pump 450. However, the portion of the tank body 441 connected to the waste collector 430 and the cleaning liquid pump 450 is not particularly limited.

The waste filter 442 may be arranged in the tank body 441 to filter the cleaning waste. The waste filter 442 may be arranged in the internal space of the tank body 441 so that the cleaning waste collected in the collector body 431 of the waste collector 430 flows in and is filtered, and the cleaning liquid regenerated from the cleaning waste is stored in the internal space of the tank body 441. For example, the waste filter 442 may have a cylindrical shape with an open top. In addition, the open top of the waste filter 442 may be connected to the lower portion of the collector body 431 so that the cleaning waste collected in the collector body 431 can flow into the open top of the waste filter 442. The cleaning waste may flow into the waste filter 442 and may be filtered by the waste filter 442, thereby regenerating the cleaning liquid from the cleaning waste. The regenerated cleaning liquid may be discharged from the waste filter 442 and stored in the tank body 441. Also, the cleaning waste from which the cleaning liquid has been regenerated may remain in the waste filter 442. A worker may remove the waste filter 442 from the tank body 441 and discard the cleaning waste remaining in the waste filter 442 to the outside. However, the shape and configuration of the waste filter 442 are not particularly limited.

The cleaning liquid pump 450 may supply the cleaning liquid stored in the cleaning liquid tank 440 to the cleaning unit 100. During cleaning of the interior of the pipe PP using the cleaning liquid, the cleaning liquid pump 450 may supply the cleaning liquid stored in the cleaning liquid tank 440 to the cleaning unit 100. The fluid supply tube 410 may be connected to the cleaning liquid pump 450 for supplying the cleaning liquid to the cleaning unit 100. For example, the fluid supply tube 410 may be connected to the cleaning liquid pump 450 through the three-way valve VL. However, the configuration in which the fluid supply tube 410 is connected to the cleaning liquid pump 450 is not particularly limited. The cleaning liquid pump 450 may be connected to the cleaning liquid tank 440. For example, the upper portion of the cleaning liquid pump 450 may be connected to the lower portion of the cleaning liquid tank 440. However, the portion of the cleaning liquid tank 440 connected to the cleaning liquid pump 450 is not particularly limited. In a state where the fluid supply tube 410 and the cleaning liquid pump 450 are connected by the three-way valve VL, the cleaning liquid pump 450 may supply the cleaning liquid stored in the cleaning liquid tank 440 to the cleaning unit 100 through the fluid supply tube 410. The cleaning liquid pump 450 may be connected to and controlled by the controller 500. For example, the cleaning liquid pump 450 may be communicatively coupled to the controller 500.

The air supplier 460 may supply air to the cleaning unit 100. After the cleaning of the interior of the pipe PP with the cleaning liquid, the air supplier 460 may supply air to the cleaning unit 100 for drying the interior of the pipe PP. The fluid supply tube 410 may be connected to the air supplier 460 to supply air to the cleaning unit 100. The fluid supply tube 410 may be connected to the air supplier 460 through the three-way valve VL. However, the configuration in which the fluid supply tube 410 is connected to the air supplier 460 is not particularly limited. In a state where the fluid supply tube 410 and the air supplier 460 are connected by the three-way valve VL, the air supplier 460 may supply air to the cleaning unit 100 through the fluid supply tube 410. The air supplier 460 may be connected to and controlled by the controller 500. For example, the air supplier 460 may be communicatively coupled to the controller 500.

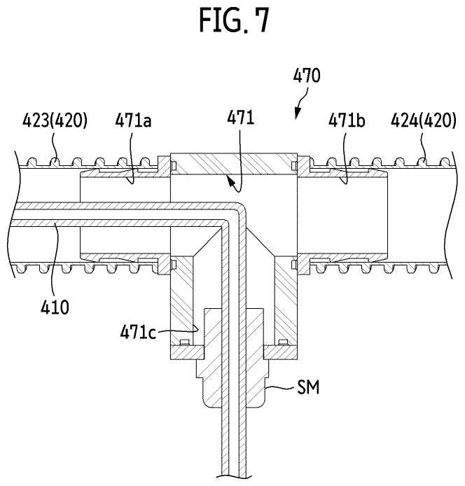

FIG. 7 is a cross-sectional view of the tube branching connector of the apparatus of FIG. 1.

Referring to FIG. 7, the tube branching connector 470 may connect the fluid supply tube 410 and the waste collection tube 420, such that the fluid supply tube 410 extends out from the inside of the waste collection tube 420 and is connected to the cleaning liquid pump 450 and the air supplier 460. A T-shaped branching flow path 471 may be formed in the tube branching connector 470. In other words, the branching flow path 471 may have three openings, i.e., first, second, and third openings 471a, 471b, and 471c.

A waste collection tube 420 with the fluid supply tube 410 arranged therein may be connected to the branching flow path 471. For example, the third waste collection tube 423, in which the fluid supply tube 410 is arranged, may be connected to the first opening 471a of the branching flow path 471. In addition, a waste collection tube 420 with no fluid supply tube 410 arranged therein may be connected to the second opening 471b of the branching flow path 471. For example, the fourth waste collection tube 424 may be connected to the second opening 471b of the branching flow path 471. Further, the fluid supply tube 410, which is arranged inside the waste collection tube 420 connected to the first opening 471a, may extend out from the waste collection tube 420, pass through the third opening 471c of the branching flow path 471, and be connected to the cleaning liquid pump 450 and the air supplier 460. For example, the fluid supply tube 410, which is arranged inside the third waste collection tube 423 connected to the first opening 471a, may extend out from the third waste collection tube 423, pass through the third opening 471c of the branching flow path 471, and be connected to the cleaning liquid pump 450 and the air supplier 460.

The third opening 471c may be sealed by a sealing member SM. The fluid supply tube 410 that has passed through the third opening 471c of the branching flow path 471 may be connected to the cleaning liquid pump 450 and the air supplier 460 via the three-way valve VL.

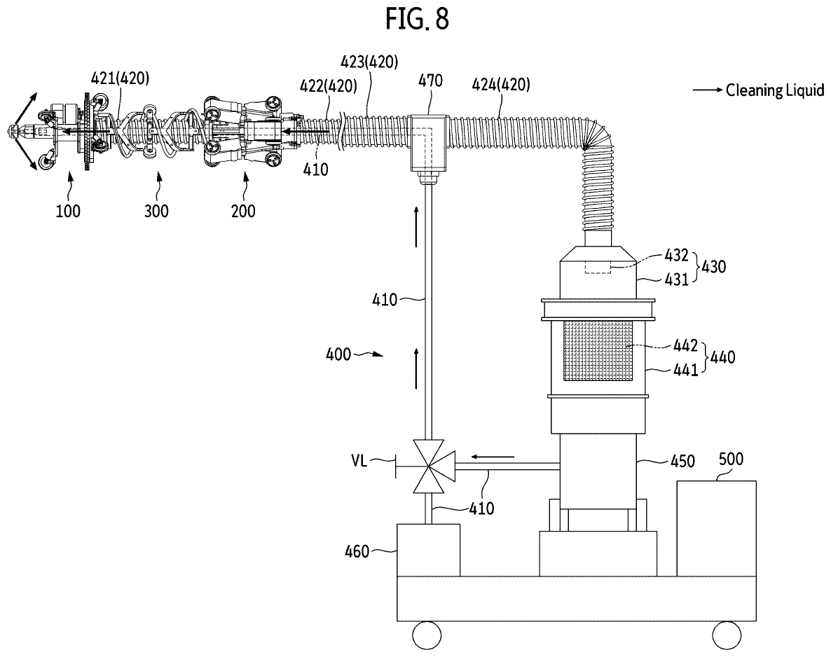

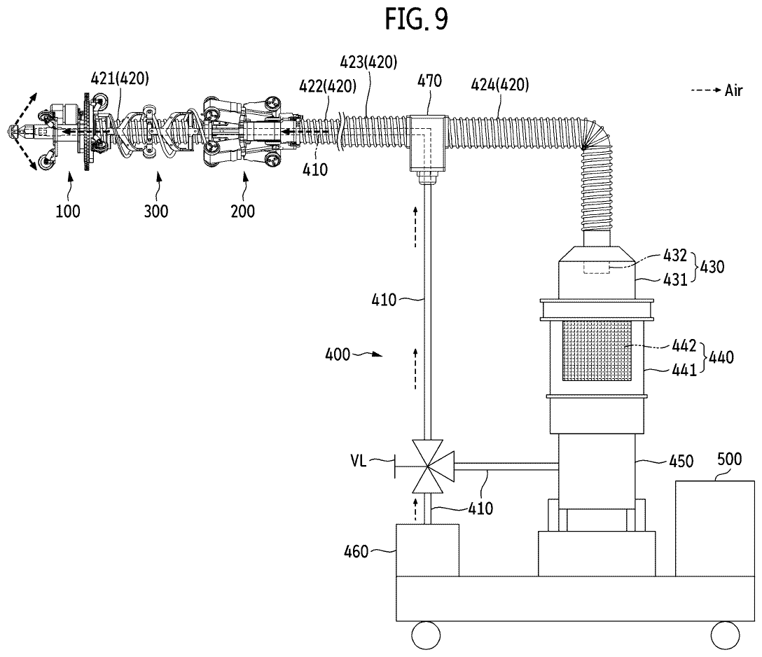

FIG. 8 is a view illustrating a state in which cleaning liquid is sprayed by the cleaning unit of the apparatus of FIG. 1, and FIG. 9 is a view illustrating a state in which air is sprayed by the cleaning unit of the apparatus of FIG. 1.

Referring to FIG. 8, during cleaning of the interior of the pipe PP with the cleaning liquid, the cleaning unit 100 may spray the cleaning liquid into the pipe PP. To allow the cleaning unit 100 to spray the cleaning liquid into the pipe PP, the fluid supply tube 410 of the collection and regeneration unit 400 may be connected to the cleaning liquid pump 450 of the collection and regeneration unit 400 via the three-way valve VL. When the cleaning liquid pump 450 is driven, the cleaning liquid in the cleaning liquid tank 440 may enter and flow along the fluid supply tube 410. The cleaning liquid that has flowed through the fluid supply tube 410 may be supplied to the cleaning unit 100 and sprayed into the interior of the pipe PP through the spray nozzle 110 of the cleaning unit 100. For example, the controller 500 may cause the three-way valve VL to be operated such that it opens in directions that allow the cleaning liquid to move from the cleaning liquid tank 440 to the fluid supply tube 410 via the three-way valve VL.

Referring to FIG. 9, during the drying of the interior of the pipe PP after the cleaning of the interior of the pipe PP with the cleaning liquid, the cleaning unit 100 may spray air into the interior of the pipe PP. To allow the cleaning unit 100 to spray air into the interior of the pipe PP, the fluid supply tube 410 of the collection and regeneration unit 400 may be connected to the air supplier 460 of the collection and regeneration unit 400 via the three-way valve VL. When the air supplier 460 is driven, air may flow into the fluid supply tube 410 and flow along the fluid supply tube 410. In addition, the air that has flowed through the fluid supply tube 410 may be supplied to the cleaning unit 100 and sprayed into the interior of the pipe PP through the spray nozzle 110 of the cleaning unit 100. For example, the controller 500 may cause the three-way valve VL to be operated such that it opens in directions that allow air to move from the air supplier 460 to the fluid supply tube 410 via the three-way valve VL.

The controller 500 may control the collection and regeneration unit 400 or the traveling unit 200 and the collection and regeneration unit 400 so that the cleaning unit 100 sprays the cleaning liquid into the interior of the pipe PP at a predetermined pressure while traveling in the first direction inside the pipe PP, thereby cleaning the interior of the pipe PP. In addition, the controller 500 may control the collection and regeneration unit 400 so that the cleaning waste is collected, the collected cleaning waste is filtered, and the cleaning liquid is regenerated from the cleaning waste. Further, the controller 500 may control the collection and regeneration unit 400 or both the traveling unit 200 and the collection and regeneration unit 400 so that, after the interior of the pipe PP is cleaned, the interior of the waste collection tube 420 of the collection and regeneration unit 400 is cleaned by the cleaning liquid. Then, the controller 500 may control the collection and regeneration unit 400 or both the traveling unit 200 and the collection and regeneration unit 400 so that, after the interior of the pipe PP and the interior of the waste collection tube 420 are cleaned, the cleaning unit 100 travels in the second direction along the cleaned interior of the pipe PP and sprays air into the pipe PP to dry the interior of the cleaned pipe PP.

The controller 500 may be implemented as hardware, firmware, software, or any combination thereof. For example, the controller 500 may be a computing device such as a workstation computer, desktop computer, laptop computer, or tablet computer. For example, the controller 500 may include a memory device such as read-only memory (ROM) or random access memory (RAM), and a processor configured to perform predetermined operations and algorithms, such as a microprocessor, central processing unit (CPU), or graphics processing unit (GPU). Additionally, the controller 500 may include a receiver and a transmitter for receiving and transmitting electrical signals.

Meanwhile, the controller 500 may learn using artificial intelligence (AI) to autonomously travel through the interior of the pipe PP and identify and clean areas that require cleaning, and may collaborate with another device to discard, to the outside, the cleaning waste remaining in the waste filter 442 of the collection and regeneration unit 400.

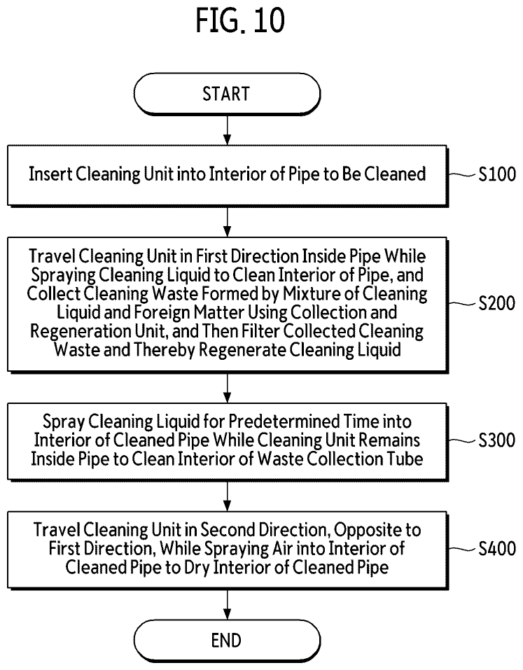

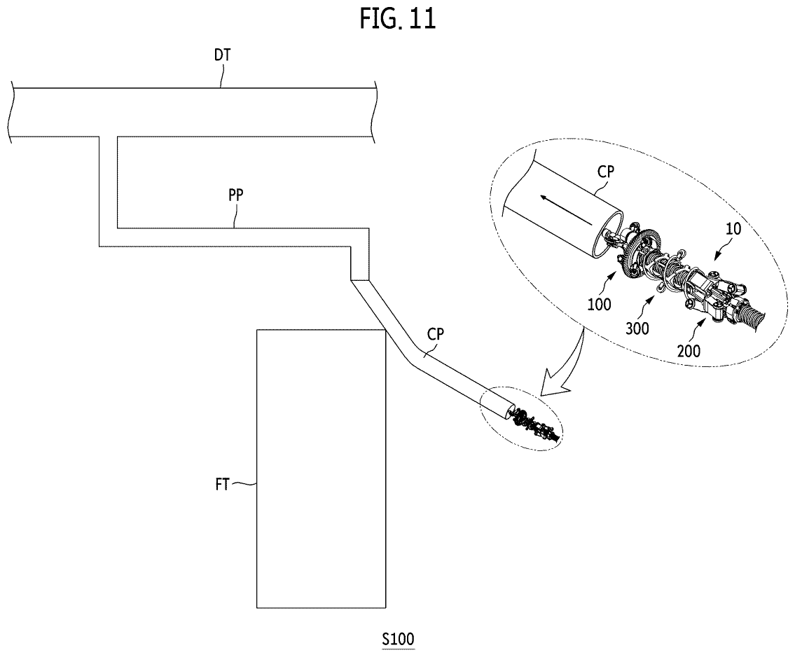

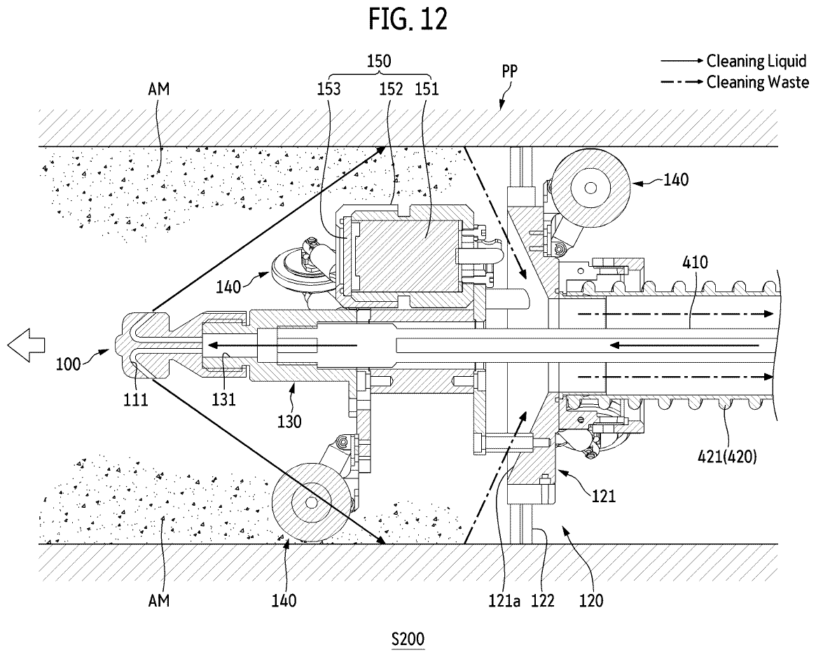

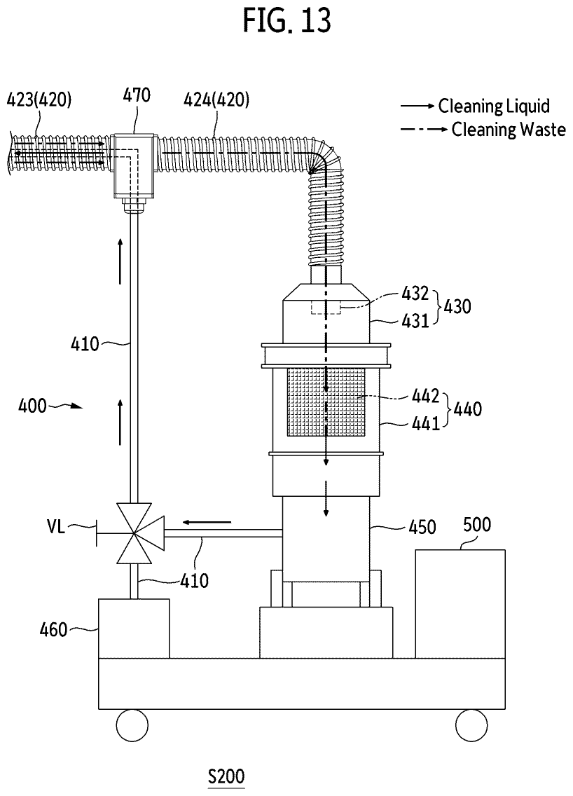

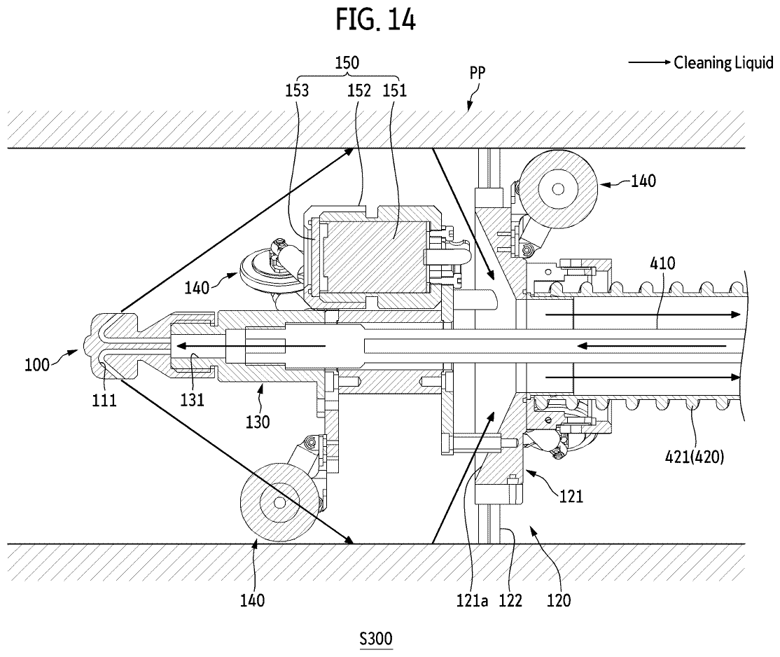

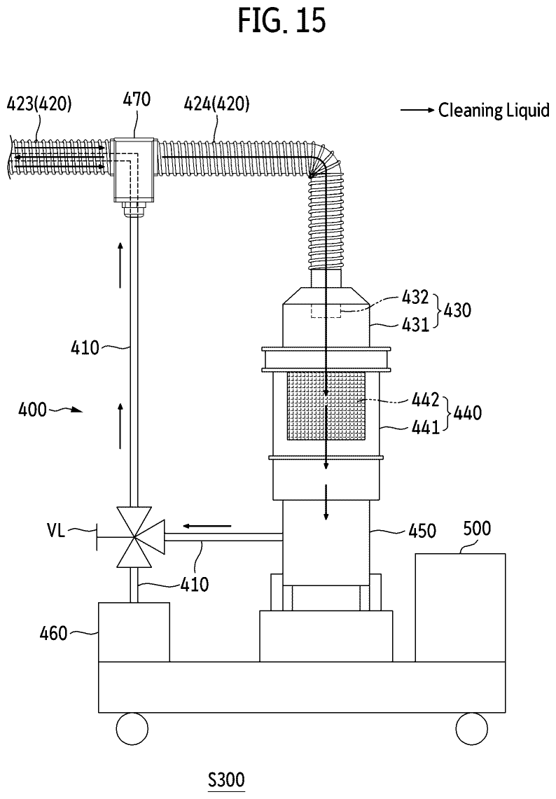

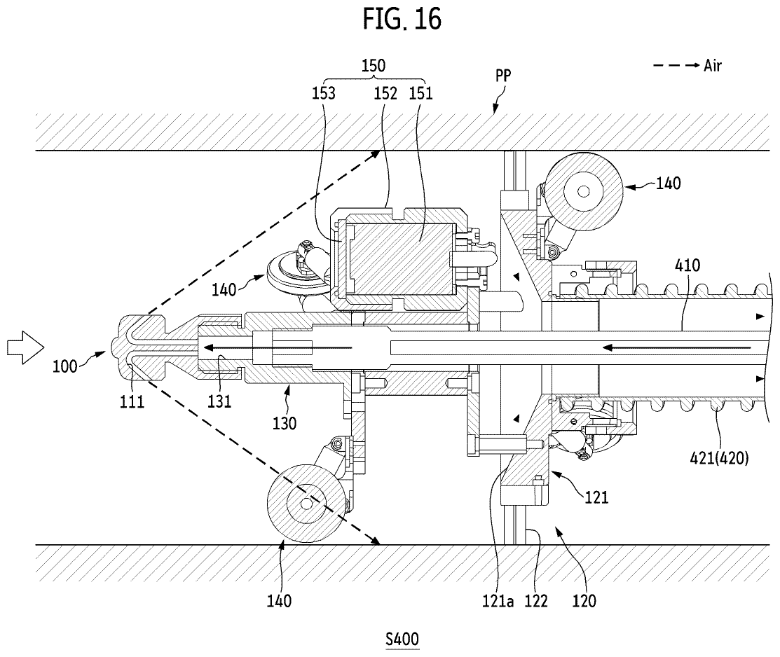

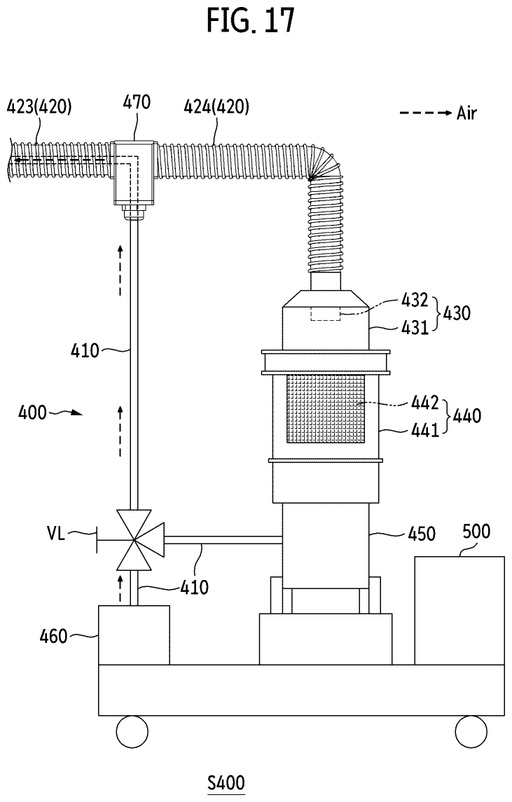

FIG. 10 is a flowchart illustrating a method of cleaning the interior of a pipe using the apparatus of FIG. 1, and FIG. 11 is a view illustrating the cleaning unit of the apparatus of FIG. 1 being inserted into the pipe to be cleaned in the method of FIG. 10. FIG. 12 is a view illustrating the cleaning unit cleaning the interior of the pipe by spraying a cleaning liquid into the pipe while traveling in the first direction inside the pipe in the method of FIG. 10, and FIG. 13 is a view illustrating the collection and regeneration unit supplying the cleaning liquid to the cleaning unit, collecting cleaning waste, and filtering the cleaning waste to regenerate the cleaning liquid from the cleaning waste in the method of FIG. 10. Further, FIG. 14 is a view illustrating the cleaning unit spraying the cleaning liquid into the cleaned pipe to clean the interior of the waste collection tube of the collection and regeneration unit after the interior of the pipe is cleaned with the cleaning liquid in the method of FIG. 10, and FIG. 15 is a view illustrating the collection and regeneration unit supplying the cleaning liquid to the cleaning unit to clean the interior of the waste collection tube of the collection and regeneration unit in the method of FIG. 10. FIG. 16 is a view illustrating the cleaning unit spraying air into the cleaned pipe to dry the interior of the cleaned pipe while traveling in the second direction in the method of FIG. 10, and FIG. 17 is a view illustrating the collection and regeneration unit supplying air to the cleaning unit to dry the interior of the cleaned pipe in the method of FIG. 10.

Referring to FIGS. 10 and 11, in the method of cleaning the interior of a pipe using the apparatus 10 of FIG. 1, the cleaning unit 100 of the apparatus 10 may first be inserted into the interior of the pipe PP to be cleaned (S100).

For example, the pipe PP to be cleaned may be a pipe that connects a scrubber, which processes by-products generated in a semiconductor manufacturing process, and an exhaust duct DT, through which gases treated by the scrubber are discharged to the outside, in a facility FT used in a semiconductor manufacturing process. However, the pipe PP to be cleaned is not particularly limited.

To insert the cleaning unit 100 into the pipe PP to be cleaned, a worker may disconnect the pipe PP to be cleaned from the facility FT to which the pipe PP is connected. Then, the worker may connect an insertion tube CP for inserting the cleaning unit 100 to the pipe PP to be cleaned. After connecting the insertion tube CP to the pipe PP to be cleaned, the worker may insert the cleaning unit 100 into the insertion tube CP. The cleaning unit 100 inserted into the insertion tube CP may move into the pipe PP to be cleaned through the spraying of the cleaning liquid or through the driving of the traveling unit 200. Alternatively to inserting the cleaning unit 100 into the pipe PP to be cleaned through the insertion tube CP, the worker may directly insert the cleaning unit 100 into the pipe PP to be cleaned.

Referring to FIGS. 10, 12, and 13, when the cleaning unit 100 is inserted into the pipe PP to be cleaned, the cleaning unit 100 may spray the cleaning liquid into the pipe PP to be cleaned and clean the interior of the pipe PP, and the collection and regeneration unit 400 of the apparatus 10 may collect the cleaning waste (S200).

The cleaning unit 100 inserted into the pipe PP to be cleaned may travel in the first direction inside the pipe PP and spray the cleaning liquid into the pipe PP to clean the interior of the pipe PP. In addition, the collection and regeneration unit 400 may collect the cleaning waste through the waste collection guide unit 120 of the cleaning unit 100 so that the cleaning waste is not discharged to the outside of the pipe PP. Then, the collection and regeneration unit 400 may filter the collected cleaning waste to regenerate the cleaning liquid from the cleaning waste.

When the cleaning unit 100 is inserted into the pipe PP to be cleaned, either directly or indirectly through the insertion tube CP, the controller 500 may drive the waste collector 430 of the collection and regeneration unit 400 and also drive the cleaning liquid pump 450 of the collection and regeneration unit 400. However, the controller 500 may also drive the cleaning liquid pump 450 and then the waste collector 430. Additionally, if the apparatus 10 includes the traveling unit 200, the controller 500 may drive the traveling unit 200.

The cleaning liquid in the cleaning liquid tank 440 of the collection and regeneration unit 400 may be supplied to the spray nozzle 110 of the cleaning unit 100 through the fluid supply tube 410 of the collection and regeneration unit 400, and the cleaning liquid may be sprayed into the interior of the pipe PP from the spray nozzle 110. For example, the cleaning liquid may be sprayed into the interior of the pipe PP from the spray nozzle 110 through the spray flow passages 111. In example embodiments, the cleaning liquid may be sprayed from the spray flow passages 111 toward the inner surface of the pipe PP in a rearward direction. In addition, the cleaning unit 100 may travel in the first direction inside the pipe PP while spraying the cleaning liquid into the interior of the pipe PP by the driving of the traveling unit 200 or the pressure of the cleaning liquid. For example, the controller 500 may control the pressure at which the cleaning liquid is supplied through the spray flow passages 111 of the spray nozzle 110. The pressure of the cleaning liquid exiting through the spray flow passages 111 of the spray nozzle 110 may propel the cleaning unit 100 in the first direction inside the pipe PP. For example, the cleaning unit 100 may be propelled in the first direction inside the pipe PP by rearward-directed spray flow passages 111, which discharge cleaning fluid opposite to the direction of travel (e.g., the first direction), generating thrust to move the cleaning unit 100 through the pipe PP. The pressure may be a pressure that is predetermined and stored in a memory of the controller 500.

Foreign matter AM inside the pipe PP is mixed with the cleaning liquid sprayed into the interior of the pipe PP, becoming cleaning waste, and the cleaning waste may be introduced into the waste collection tube 420 of the collection and regeneration unit 400 via the waste collection guide unit 120 of the cleaning unit 100, instead of being discharged to the outside of the pipe PP. The cleaning waste introduced into the waste collection tube 420 may flow through the waste collection tube 420 and be collected in the waste collector 430 of the collection and regeneration unit 400. The cleaning waste collected in the waste collector 430 may be filtered by the waste filter 442 of the cleaning liquid tank 440 of the collection and regeneration unit 400, and the cleaning liquid may be regenerated from the cleaning waste. The regenerated cleaning liquid may be stored in the cleaning liquid tank 440 and supplied again to the cleaning unit 100 as the cleaning liquid.

The cleaning waste from which the cleaning liquid has been regenerated may remain in the waste filter 442 of the cleaning liquid tank 440 of the collection and regeneration unit 400. When the cleaning of the interior of the pipe PP with the cleaning liquid is completed, the cleaning waste remaining in the waste filter 442 may be discarded to the outside by separating the waste filter 442 from the cleaning liquid tank 440. Alternatively, when the cleaning of the interior of the waste collection tube 420 with the cleaning liquid is completed, the cleaning waste remaining in the waste filter 442 may be discarded to the outside by separating the waste filter 442 from the cleaning liquid tank 440. In addition, when the drying of the cleaned interior of the pipe PP is completed, the cleaning waste remaining in the waste filter 442 may be discarded to the outside by separating the waste filter 442 from the cleaning liquid tank 440.

Referring to FIGS. 10, 14, and 15, when the cleaning of the interior of the pipe PP with the cleaning liquid is completed, the cleaning unit 100 may be positioned at the opposite end from the end where the cleaning unit 100 was initially inserted into the interior of the pipe PP. In this state, the cleaning unit 100 may spray the cleaning liquid into the interior of the cleaned pipe PP for a predetermined amount of time, thereby cleaning the interior of the waste collection tube 420 (S300).

When the cleaning unit 100, traveling in the first direction inside the pipe PP, is positioned at the opposite end from the side where the cleaning unit 100 was initially inserted, the controller 500 may stop the driving of the traveling unit 200. In addition, when the driving of the traveling unit 200 is stopped, the controller 500 may control the cleaning liquid pump 450 of the collection and regeneration unit 400 to spray the cleaning liquid from the cleaning unit 100 into the interior of the pipe PP for a predetermined amount of time. The predetermined amount of time may be stored in a memory of the controller 500, and may be used by the controller 500 to control the cleaning liquid pump 450 of the collection and regeneration unit 400.

Alternatively, the cleaning unit 100 may be positioned at the opposite end from the end where the cleaning unit 100 was initially inserted into the pipe PP, by traveling in the first direction inside the pipe PP through the spraying of the cleaning liquid. In this case, the controller 500 may control the cleaning liquid pump 450 of the collection and regeneration unit 400 such that the spraying pressure of the cleaning liquid is lowered to a pressure at which the cleaning unit 100 cannot continue traveling in the first direction. Then, the controller 500 may control the cleaning liquid pump 450 so that the cleaning liquid is sprayed from the cleaning unit 100 into the interior of the pipe PP for a predetermined time at the lowered pressure.

The cleaning liquid sprayed from the cleaning unit 100 into the interior of the cleaned pipe PP may be introduced into the interior of the waste collection tube 420 of the collection and regeneration unit 400 via the waste collection guide unit 120 of the cleaning unit 100 and may flow through the waste collection tube 420. While flowing through the waste collection tube 420, the cleaning liquid may mix with cleaning waste remaining in the waste collection tube 420. The cleaning liquid and the cleaning waste may be collected into the waste collector 430 of the collection and regeneration unit 400 through the waste collection tube 420. The cleaning waste that has flowed into the waste collector 430 may flow into the cleaning liquid tank 440 of the collection and regeneration unit 400 and be filtered by the waste filter 442 of the cleaning liquid tank 440. As a result, the cleaning liquid may be regenerated from the cleaning waste, and the regenerated cleaning liquid may be stored in the cleaning liquid tank 440.

Referring to FIGS. 10, 16, and 17, when the cleaning of the interior of the waste collection tube 420 is completed, the cleaning unit 100 may dry the interior of the cleaned pipe PP (S400). The cleaning unit 100 may dry the interior of the cleaned pipe PP while traveling in the second direction inside the cleaned pipe PP. While the cleaning unit 100 travels in the second direction inside the cleaned pipe PP, the waste flow blocking members 122 of the waste collection guide unit 120 of the cleaning unit 100 may remove the cleaning liquid from the inner wall of the cleaned pipe PP, thereby drying the interior of the cleaned pipe PP. In addition, while the cleaning unit 100 travels in the second direction inside the cleaned pipe PP, the cleaning unit 100 may spray air into the pipe PP, thereby drying the interior of the cleaned pipe PP.

When the cleaning of the interior of the waste collection tube 420 of the collection and regeneration unit 400 is completed, the controller 500 may control the traveling unit 200 to travel in the second direction inside the cleaned pipe PP. Alternatively, when the cleaning unit 100 travels in the first direction inside the pipe PP by spraying the cleaning liquid, and the cleaning of the interior of the waste collection tube 420 of the collection and regeneration unit 400 is completed, the cleaning unit 100 may travel in the second direction inside the cleaned pipe PP by the worker.

The controller 500 may drive the air supplier 460 of the collection and regeneration unit 400 to spray air from the cleaning unit 100 into the interior of the cleaned pipe PP.

When the cleaning and drying of the interior of the pipe PP are completed, the controller 500 may stop the driving of the traveling unit 200. In addition, the controller 500 may stop the driving of the air supplier 460 and the waste collector 430 of the collection and regeneration unit 400. Meanwhile, the stopping of the driving of the waste collector 430 by the controller 500 may be performed after the cleaning of the interior of the pipe PP with the cleaning liquid or after the cleaning of the interior of the waste collection tube 420 of the collection and regeneration unit 400 with the cleaning liquid.

When the cleaning and drying of the interior of the pipe PP are completed, the worker may remove the cleaning unit 100 from the interior of the pipe PP that has been cleaned and dried.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above are not restrictive but illustrative in all respects.

What is claimed is:

1. An apparatus for cleaning an interior of a pipe, comprising:
a cleaning unit configured to spray a cleaning liquid into the interior of the pipe at a predetermined pressure and thereby clean the interior of the pipe while traveling in a first direction inside the pipe; and
a collection and regeneration unit configured to supply the cleaning liquid to the cleaning unit, collect cleaning waste formed by a mixture of the cleaning liquid sprayed into the interior of the pipe and foreign matter from the inside of the pipe, and filter the collected cleaning waste and thereby regenerate the cleaning liquid from the cleaning waste.

2. The apparatus of claim 1, wherein the cleaning unit is further configured to spray the cleaning liquid at an angle between a direction perpendicular to the first direction and a second direction opposite to the first direction, or in the direction perpendicular to the first direction.

3. The apparatus of claim 1,
wherein the collection and regeneration unit includes:
a fluid supply tube connected to the cleaning unit such that the cleaning liquid is supplied to the cleaning unit; and
a waste collection tube connected to the cleaning unit such that the cleaning waste is collected through the cleaning unit,
wherein a diameter of the fluid supply tube is smaller than a diameter of the waste collection tube, and
wherein at least a portion of the fluid supply tube is positioned inside the waste collection tube.

4. The apparatus of claim 3, wherein the cleaning unit includes:
a spray nozzle connected to the fluid supply tube and configured to spray the cleaning liquid into the interior of the pipe; and
a waste collection guide connected to the waste collection tube and configured to guide the cleaning waste such that the cleaning waste flows into and is collected in the waste collection tube and is not discharged to an outside of the pipe.

5. The apparatus of claim 4, wherein the waste collection guide includes:
a collection guide member having a collection guide passage formed therein, the collection guide passage having a first end that is open such that the cleaning waste flows in and a second end connected to the waste collection tube; and
a waste flow blocking member connected to a circumference of the collection guide member such that the waste flow blocking member is positioned between the collection guide member and an inner wall of the pipe, and configured to block the cleaning waste from flowing through a space between the collection guide member and the inner wall of the pipe.

6. The apparatus of claim 5,
wherein a diameter of the waste collection guide is a first diameter, a diameter of the collection guide member is a second diameter, and a distance between the collection guide member and the inner wall of the pipe, which is a curved pipe, on its radially outer side is a first length, and
wherein the first diameter is greater than a sum of the second diameter and twice the first length.

7. The apparatus of claim 4,
wherein the cleaning unit further includes a nozzle support member connected to the waste collection guide,
wherein the spray nozzle is detachably connected to the nozzle support member, and
wherein the fluid supply tube is connected to the nozzle support member to be connected to the spray nozzle.

8. The apparatus of claim 4, wherein the cleaning unit further includes a plurality of nozzle centering units configured to support the spray nozzle such that the spray nozzle is positioned at a center portion inside the pipe.

9. The apparatus of claim 8, wherein each of the nozzle centering units includes:
a centering wheel at least partially in contact with an inner wall of the pipe; and
a centering wheel support connected to the cleaning unit, having the centering wheel rotatably arranged therein, and configured to elastically support the centering wheel.

10. The apparatus of claim 4, wherein the cleaning unit further includes a pipe interior imaging unit including a camera configured to capture an image of the interior of the pipe.

11. The apparatus of claim 2, wherein the cleaning unit is further configured to spray the cleaning liquid at the angle between the direction perpendicular to the first direction and the second direction and thereby travel in the first direction inside the pipe.

12. The apparatus of claim 3, further comprising:
a traveling unit detachably connected to the cleaning unit, configured to move the cleaning unit in the first direction or a second direction opposite to the first direction, and further configured such that the fluid supply tube passes through the traveling unit and the waste collection tube is connected to the traveling unit.

13. The apparatus of claim 12, wherein the traveling unit includes:
a traveling unit body detachably connected to the cleaning unit, having a waste flow passage formed therein, and configured such that the fluid supply tube passes through the waste flow passage and the waste collection tube is connected to the waste flow passage; and
a plurality of traveling drivers connected to the traveling unit body and configured to generate driving force to allow the cleaning unit to travel inside the pipe.

14. The apparatus of claim 12, further comprising:
a flexible connection unit flexibly connecting the cleaning unit and the traveling unit, detachably connected to the cleaning unit and the traveling unit, and configured such that the waste collection tube, within which the fluid supply tube is arranged, passes through the flexible connection unit.

15. The apparatus of claim 14, wherein the flexible connection unit includes a plurality of flexible connection members flexibly connected to each other and forming a space through which the waste collection tube passes.

16. The apparatus of claim 3, wherein the collection and regeneration unit includes:
a waste collector connected to the waste collection tube and configured to collect the cleaning waste;
a cleaning liquid tank configured to store the cleaning liquid to be supplied to the cleaning unit and in which the cleaning waste collected in the waste collector is filtered to be regenerated and stored as the cleaning liquid; and
a cleaning liquid pump connected to the fluid supply tube and configured to supply the cleaning liquid from the cleaning liquid tank to the cleaning unit.

17. The apparatus of claim 16, wherein the collection and regeneration unit further includes a pipe branching member configured to connect the fluid supply tube and the waste collection tube, such that the fluid supply tube extends from an inside of the waste collection tube to an outside and is connected to the cleaning liquid pump.

18. The apparatus of claim 16,
wherein the cleaning unit is further configured to spray air into the interior of the pipe while traveling in a second direction, which is opposite to the first direction, after cleaning the interior of the pipe with the cleaning liquid, thereby drying the interior of the pipe that has been cleaned, and
wherein the collection and regeneration unit further includes an air supplier connected to the fluid supply tube and configured to supply the air to the cleaning unit through the fluid supply tube.

19. An apparatus for cleaning an interior of a pipe, comprising:
a cleaning unit configured to spray a cleaning liquid into the interior of the pipe at a predetermined pressure and thereby clean the interior of the pipe, or spray air into the interior of the pipe that has been cleaned and thereby dry the interior of the pipe that has been cleaned, while traveling inside the pipe; and
a collection and regeneration unit configured to supply the cleaning liquid or the air to the cleaning unit, collect cleaning waste formed by a mixture of the cleaning liquid sprayed into the interior of the pipe and foreign matter from the inside of the pipe, and filter the collected cleaning waste and thereby regenerate the cleaning liquid from the cleaning waste,
wherein the collection and regeneration unit includes:
a waste collector configured to collect the cleaning waste;
a cleaning liquid tank configured to store the cleaning liquid to be supplied to the cleaning unit and in which the cleaning waste collected in the waste collector is filtered to be regenerated and stored as the cleaning liquid;
a cleaning liquid pump configured to supply the cleaning liquid from the cleaning liquid tank to the cleaning unit; and
an air supplier configured to supply the air to the cleaning unit.

20. An apparatus for cleaning an interior of a pipe, comprising:
a cleaning unit configured to travel inside the pipe and spray a cleaning liquid into the interior of the pipe at a predetermined pressure to clean the interior of the pipe;
a traveling unit detachably connected to the cleaning unit and configured to move the cleaning unit inside the pipe;
a flexible connection unit detachably connected to the cleaning unit and the traveling unit and configured to flexibly connect the cleaning unit and the traveling unit; and
a collection and regeneration unit configured to supply the cleaning liquid to the cleaning unit, collect cleaning waste formed by a mixture of the cleaning liquid sprayed into the interior of the pipe and foreign matter from the inside of the pipe, and filter the collected cleaning waste to regenerate the cleaning liquid from the cleaning waste.
